(19) United States
(12) Patent Application Publication
(10) Pub. No.: US 2011/0196825 A1
(43) Pub. Date: Aug. 11, 2011

(54) STORAGE SYSTEM AND DATA DUPLICATION METHOD IN THE SAME

(75) Inventors: Toru Suzuki, Odawara (JP); Katsuhiro Okumoto, Odawara (JP)

(73) Assignee: HITACHI, LTD., Tokyo (JP)

(21) Appl. No.: 12/671,057

(22) PCT Filed: Sep. 29, 2009
(86) PCT No.: PCT/JP2009/005003

§ 371 Date: Jan. 28, 2010

(51) Int. Cl. G06F 17/30

(52) U.S. Cl. 707/613; 707/E17.005

(57) ABSTRACT

A storage system has a primary storage device for storing data from host devices, and first and second secondary storage devices. When either the primary storage device or the first secondary storage device is in the process of maintenance and a failure occurs in the other secondary storage device data received from the host device is not lost, and the processing continues from the relevant data. The host device processor makes the first and second secondary storage devices perform a resync processing with reference to a relevant trigger that the respective status of the primary device and the first secondary storage device are both changed to the Suspend status. Then an I/O control unit copies the differential data between the copy data of the first secondary volume and the second secondary volume and transfers the data from the first secondary storage devices to the second secondary storage device.

### TECHNICAL FIELD

The present invention relates to a storage system comprising a primary storage device for storing data from host devices and first and second secondary storage devices, specifically to the technology of, even if a failure occurs in any of these, continuing data processing by using any of the storage devices, and is appropriate for storage systems and data duplication methods in the storage systems.

### BACKGROUND ART

Due to the recent development of information industry, various types of storage system are developed. Conventional storage systems adopt the redundant configuration in which multiple storage devices for storing data from host devices are comprised and, even if a failure occurs or maintenance is in process in one of the storage devices, the other storage devices are available.

In conventional storage systems, a host device issues a write command to one storage device and makes the volumes in the relevant one storage device (hereinafter referred to as a “primary storage device”) store the data while, synchronously with this storage processing, making the volumes in the above-mentioned other storage device (hereinafter referred to as a “secondary storage device”) store the copy data of the data. In this type of redundant configuration, according to the conventional storage system, if a failure occurs in a primary storage device, it was possible to continue the processing by using the copy data in the secondary storage device.

Furthermore, some of recent storage systems adopt the configuration in which this secondary storage device is duplicated (refer to Patent Literature 1). In the description below, these secondary storage devices are referred to as the first and second secondary storage devices. In this type of storage system, the copy data stored in the first secondary storage device is transferred to the second secondary storage device asynchronously. That is, in the conventional storage system, it is possible to, among the components i.e. the primary storage device and the first and second secondary storage devices, attempt to maintain the data consistency and duplicate data fast and efficiently and, if a failure occurs in any of these components, reduce time required before resuming the data duplication processing.

In The storage system, if failures occur in the primary storage device and in the first secondary storage device, or if one is in process of maintenance and a failure occurs in the other, the host computer was, after that, able to use the data remaining in the second secondary storage device and perform the data processing from that point of time.

### CITATION LIST

### Patent Literature

Patent Literature 1: Japanese Published Unexamined Patent Application No. 2005-316684

### SUMMARY OF INVENTION

### Technical Problem

As mentioned above, in the conventional storage system, though, even if the above-mentioned failures occurred, the operation could be continued by using the second secondary storage device, the following inconveniences existed. That is, in the conventional storage system, as data copy was performed asynchronously between the first and second secondary storage devices, depending on the time when the failure occurred, there were some cases where, though the data was the same in the primary storage device and in the first secondary storage device, data was different between the first and second secondary storage devices.

In this type of case, in the conventional storage system, as the processing could not be resumed, by using the second secondary storage device, continued from the data right before the relevant failure occurred, there was a risk that part of the data might be lost. Related to this, in the case where a failure occurred in the primary storage device when the first secondary storage device is in process of maintenance, also, there was a risk that part of the relevant data might be lost for the same reason.

The present invention is intended considering the above-mentioned items and suggests a storage system and a data duplication method in the storage system by which, even if either the primary storage device or the first secondary storage device is in process of maintenance and a failure occurs in the other storage device, data received from the host device is not lost and, the processing can be resumed from the latest status of the relevant data.

### Solution to Problem

For resolving the above-mentioned problems, the present invention is characterized by comprising a primary volume storing data from a host device, on which data write is suspended with reference to a command from the host device, a first secondary storage device comprising a first secondary volume storing copy data of the data stored in the primary volume, and a second secondary storage device comprising a second secondary volume storing the copy data of the data stored in the primary volume; wherein the host device transfers differential data between the respective copy data stored in the first and second secondary volumes from the first secondary storage device to the second secondary storage device with reference to a trigger that both status of the primary storage device and the first secondary storage device were changed to suspend status.

For resolving the above-mentioned problems, the present invention is characterized, in the data duplication method in the storage system comprising a primary storage device comprising a primary volume storing data from a host device, on which data write is suspended based on a command from the host device a first secondary storage device comprising a first secondary volume storing copy data of the data stored in the primary volume, and a second secondary storage device comprising a second secondary volume storing the copy data of the data stored in the primary volume, wherein the data duplication method comprising an acquisition step at which the host device acquires respective status of the primary storage device and the first secondary storage device, and a transfer step at which the host device transfers differential data between the respective copy data stored in the first and second secondary volumes from the first secondary storage device to the second secondary storage device with reference to a trigger that both status of the primary storage device and the first secondary storage device were changed to suspend status.

### Advantageous Effects of Invention

According to the present invention, even if either the primary storage device or the first secondary storage device is in process of maintenance and a failure occurs in the other secondary storage device, data received from the host device is not lost, and the processing can be resumed continuously from the relevant data.

### BRIEF DESCRIPTION OF DRAWINGS

FIG. 1 is a schematic block diagram showing the configuration of a storage system in the present embodiment.

FIG. 2 is a block diagram showing an example of the configuration of each storage device.

FIG. 3 is a diagram showing an example of the basic configuration of a data processing system.

FIG. 4 is a diagram showing an operation example in each storage device during the normal operation.

FIG. 5 is a diagram showing an operation example of each storage device when the primary storage device is in process of maintenance.

FIG. 6 is a diagram showing an operation example of each storage device when the primary storage device is in process of maintenance.

FIG. 7 is a diagram showing an operation example of each storage device when the first secondary storage device is in process of maintenance.

FIG. 8 is a diagram showing an operation example of each storage device when the first secondary storage device is in process of maintenance.

FIG. 9 is a diagram showing an operation example of each storage device when the second secondary storage device is in process of maintenance.

FIG. 10 is a diagram showing an operation example of each storage device when the second secondary storage device is in process of maintenance.

FIG. 11 is a diagram showing an operation example in case a failure occurs in the first secondary storage device when the primary storage device is in process of maintenance.

FIG. 12 is a diagram showing an operation example in case a failure occurs in the first secondary storage device when the primary storage device is in process of maintenance.

FIG. 13 is a diagram showing an operation example in case a failure occurs in the primary storage device when the first secondary storage device is in process of maintenance.

FIG. 14 is a diagram showing an operation example in case a failure occurs in the primary storage device when the first secondary storage device is in process of maintenance.

FIG. 15 is a diagram showing the status before a synchronous pair is created in a pair status management table.

FIG. 16 is a diagram showing an example of the process where a synchronous pair is created in the pair status management table.

FIG. 17 is a diagram showing an example where a first asynchronous pair is created in the pair status management table.

FIG. 18 is a diagram showing an example where a first asynchronous pair is created in the pair status management table.

FIG. 19 is a diagram showing the status of the pair status management table when maintenance is performed for the primary storage device.

FIG. 20 is a diagram showing the status of the pair status management table when maintenance is performed for the primary storage device.

FIG. 21 is a diagram showing the status of the pair status management table when maintenance is performed for the primary storage device.

FIG. 22 is a diagram showing the status of the pair status management table when the primary storage device is in process of maintenance and a failure occurs in the first secondary storage device.

FIG. 23 is a diagram showing the status of the pair status management table when the primary storage device is in process of maintenance and a failure occurs in the first secondary storage device.

FIG. 24 is a diagram showing the status of the pair status management table when a failure occurs in the primary storage device during the normal operation.

FIG. 25 is a diagram showing the status of the pair status management table when a failure occurs in the primary storage device during the normal operation.

FIG. 26 is a diagram showing the status of the pair status management table when a failure occurs in the primary storage device during the normal operation.

FIG. 27 is a flowchart showing an example of the procedure in the resync processing.

FIG. 28 is a diagram showing a configuration example of a configuration information file of a synchronous pair.

FIG. 29 is a diagram showing a configuration example of a configuration information file of an asynchronous pair.

FIG. 30 is a flowchart showing an operation example in the first secondary storage device.

FIG. 31 is a diagram showing a configuration example of a pair status management table of a synchronous pair.

FIG. 32 is a flowchart showing an example of the procedure in the resync processing for the second asynchronous pair.

FIG. 33 is a flowchart showing the detailed contents of the resync processing shown in FIG. 32.

FIG. 34 is an example of a management table of a CU: VOL# belonging to a Group #Z.

FIG. 35 is an example of a management table of a CU: VOL# belonging to a Group #Z.

FIG. 36 is an example of the management table of CUs: VOL# and pair management IDs.

FIG. 37 is a diagram showing an example of a pair status management table of each pair management ID.

FIG. 38 is a flowchart showing an example of the processing for returning to the normal status.

FIG. 39 is a flowchart showing the detailed contents of the processing for returning to the normal status.

FIG. 40 is a flowchart showing an example of the procedure in the differential data copy method in the resync processing.

FIG. 41 is a diagram showing an example of journal control information.

FIG. 42 is a diagram showing an example of a journal management table.

FIG. 43 is a diagram showing an example of a journal management table.

FIG. 44 is a diagram showing an example of the method for creating differential data.

### REFERENCE SIGN LIST

1: Storage system, 100: Host computer, 100a: Input/output control unit, 100b: Synchronous pair status management unit, 100c: Asynchronous pair management unit, 200: Primary storage device, 200a: Primary volume, 200b: Synchronous pair, 200c: Asynchronous pair, 200d: Pair status management table, 300: First secondary storage device, 300a: First secondary volume, 300b: Synchronous pair, 300c: Asynchronous pair, 300d: Pair status management table, 400: Second secondary storage device, 400a: Second secondary volume, 400b: Synchronous pair, 400c: Asynchronous pair, 400d: Pair status management table.

### DESCRIPTION OF EMBODIMENT

An embodiment of the storage system where the present invention is applied is described below in details with reference to attached figures.

(1) Storage System Configuration in the Present Embodiment

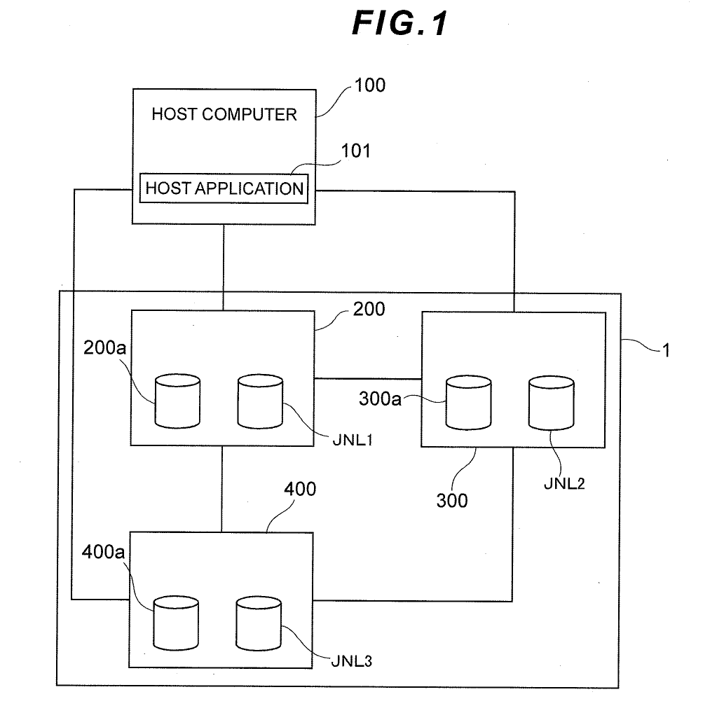

FIG. 1 is a schematic block diagram showing the configuration of a storage system in the present embodiment. The storage system 1 comprises multiple storage devices comprising storage areas storing data. The storage system, as this type of storage devices, comprises the storage devices 200, 300, and 400, and stores data from the host computer 100 as a host device in any of the storage devices 200 and others. The host computer 100 is a computer such as desktop, notebook, workstation or mainframe.

The host computer 100 comprises a CPU (Central Processing Unit), a memory, cache, hard disk drives, interfaces and various types of interface cards. The host computer 100 realizes various functions by the embedded processor performing various programs in the memory. These various programs are equivalent to a host application 101 shown in the figure. The host computer 100 performs data processing by accessing the data mainly stored in the primary storage device 200. The relevant data is equivalent to the above-mentioned duplication source data.

In this storage system 1 the host computer 100 issues write commands to the storage device 200 and store data to the storage device 200. On the other hand, the storage device 200 stores duplicated data of the relevant data to another storage device 300. The storage system 1 continues the processing by using the data duplicated in the storage device 300 if a failure occurs in the storage device 200.

In the present embodiment, for distinguishing the storage device storing the duplication target data (hereinafter referred to as “duplication source data”) from the storage device storing the data acquired by duplicating the relevant duplication source data (hereinafter referred to as “duplicated data”), the device storing the duplication source data is defined as “primary,” and the device storing the duplicated data is defined as “secondary.” In the present embodiment, according to the primary and secondary status, the storage device storing duplication source data is referred to as a “primary storage device” while the storage device storing duplicated data is referred to as a “secondary storage device.” Note that, in the present embodiment, the primary storage device is also referred to as a “PVOL” and the secondary storage device is also referred to as an “SVOL.”

The respective storage devices 200, 300, and 400 are connected with each other by the network or dedicated lines, and communication is performed in accordance with a specific communication protocol. The secondary storage device 300, by the synchronous data duplication processing which is described later, copies the data stored in the primary storage device 200 and stores the relevant duplicated data. The secondary storage device 400, by the asynchronous data duplication processing which is described later, copies the data stored in the primary storage device 200 and stores the relevant duplicated data.

When the duplication source data is updated the primary storage device 200 creates a journal related to the relevant updated contents and stores the journal data JNL1 in the storage area. The primary storage device 200 duplicates data based on this journal data JNL1. When the copy data from the primary storage device 200 is updated the first and second secondary storage devices 300 and 400 respectively create journals related to the relevant updated contents, and store journal data JNL2 and JNL3 in the storage areas, as almost same as the primary storage device 100. The primary storage device 200 makes match the duplication source data by transferring required journal data between the storage devices 300 and 400 and updating the duplicated data of the other storage devices by the relevant journal data.

In the data duplication methods (modes) between storage devices 200 there are synchronous data duplication and asynchronous data duplication. In the normal operation, by performing the two types of data duplication, synchronous data duplication and asynchronous data duplication, among the three storage devices 200, 300, and 400, two pieces of duplicated data are maintained for one piece of duplication source data. Synchronous data duplication is the processing of updating duplicated data synchronously with the updates of the duplication source data, and the duplicated data matches the duplication source data. On the other hand, asynchronous data duplication is the processing of updating duplicated data with reference to journals, and the duplicated data matches the duplication source data after updated.

The storage system 1 in the present embodiment, in the normal operation, performs data duplication among storage devices i.e. maintains the sustained status of the duplicated data. if a failure occurs in a storage device the storage system 1 continues the above-mentioned data duplication and resumes the processing by transferring journals between the storage devices not in the failure status and reflecting the updates by the journal data.

In this situation, the storage areas of the storage device are logically partitioned and managed, and the partitioned storage areas are referred to as logical volumes (hereinafter simply referred to as “volumes”). For managing the order of updating the data in and among these logical volumes, the management unit, which is called a group, is set.

Storage Device Configuration

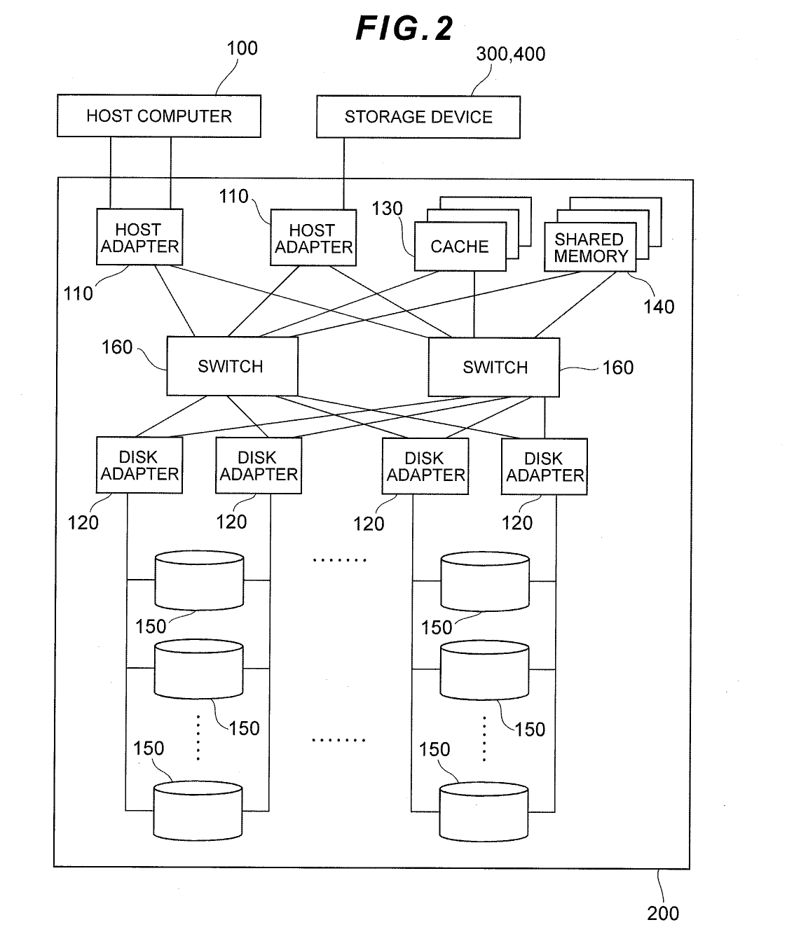

FIG. 2 is a block diagram showing an example of the hardware configuration of the primary storage device 200. Note that, in FIG. 2, the hardware configuration of the primary storage device 200 is mainly described, but the configuration of the above-mentioned first and second secondary storage devices is almost same each other.

The primary storage device 200 comprises a CHA (host adapter) 110, a DKA (disk adapter) 120, a CACHE (a cache memory) 130, an SM (a shared memory) 140, HDDs (hard disk drives) 150, and a SWITCH (switch) 160. The host adapter 110, the disk adapter 120, the cache memory 130 and the shared memory 140 are connected with each other via the switches 160. Multiple hard disk drives 150 are set and configure the so-called RAID (Redundant Array of Inexpensive Disks).

The primary storage device 200 comprises the host adapter 110 and the disk adapter 120 as the control unit for the command reception processing and other various types of processing. The primary storage device 200 performs the programs corresponding to the various types of processing by the embedded processor. The relevant programs are equivalent to the host application described later. The host adapter 110 comprises a communication interface for communicating with the host computer 100 and the function for sending/receiving the input/output commands. The host adapter 110 controls the data transfer between the host computer 100 and the cache memory 130. The host adapter 110 is connected to the host computer 100 and the secondary storage device 300, 400. The disk adapter 120 performs the control such as data read and write for the hard disk drives 150, and controls the data transfer between the cache memory 130 and the hard disk drives 150.

The cache memory 130 is a type of memory mainly for temporarily storing the data received from the host computer 100 and the data read from the hard disk drives 150. The shared memory 140 is the memory shared and used by all the host adapters 110 and disk adapters 120 in the storage device 200, mainly storing the control information and other types of information.

Journal Configuration

A journal is the data created, when the duplication source data maintained by storage device 200 (primary volume) is updated, as the information related to data update. The journal includes write data and update information. The write data is the copy of the data used at the time of the update processing for the data in the primary volume from the host computer 100. The relevant data is the write data for the update position.

The relevant update information is information for managing the write data and the journal at each update, and includes the time (update time) as the timestamp of receiving the write command, the management number, the logical address of the write command, the data size of the write data, and others. The relevant update information, as the identifier of the data update, includes at least either one of the time (update time) as the timestamp of receiving the above-mentioned write command or the management number. The data update order is identified with reference to the relevant update information.

(2) Configuration of Function of Host Computer 100

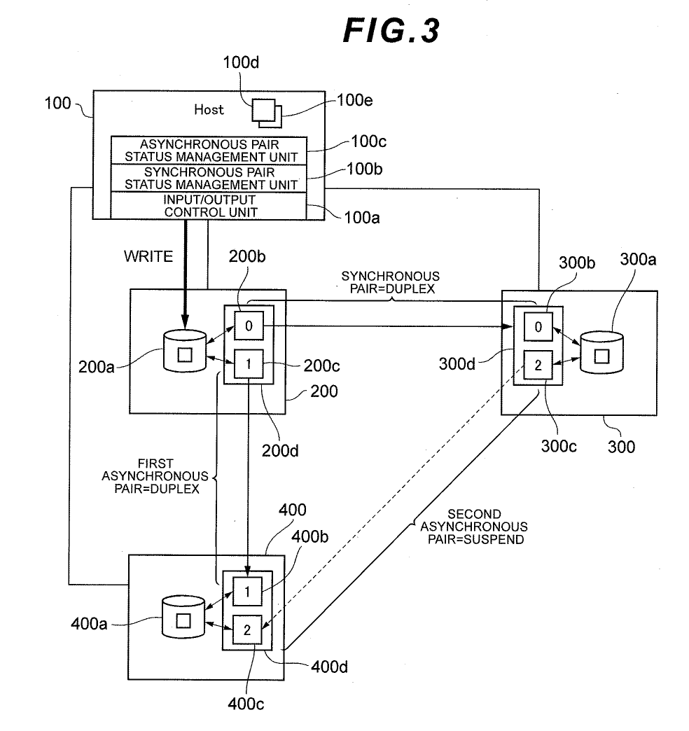

FIG. 3 is a diagram showing an example of the basic configuration of a data processing system comprising the host computer 100 and the storage system 1. The host computer 100, as the host application operated by the processor, loads the input/output (hereinafter also referred to as “I/O”) control unit 100a and the status management units 100b and 100c and, as the files, comprises the configuration information files 100d and 100e of the synchronous pair and asynchronous pair to be described later.

The synchronous pair configuration information file 100d includes the synchronous pair information to be described later. The asynchronous pair configuration information file 100e includes the asynchronous pair information to be described later. As this asynchronous pair information, two types exist in accordance with the first and second asynchronous pairs, and may also be permitted to exist as separate files. In the present embodiment, the above-mentioned input/ output control unit 100a, the synchronous pair status management unit 100b and 100c are also collectively referred to as the host application.

The above input/output control unit 100a comprises the function of issuing commands required for instructing the primary storage device 200 and the first and second secondary storage devices 300 and 400 for writing and reading data.

The status management units 100b and 100c are the application software for acquiring and managing the status of the primary storage device 200 and the first and second secondary storage devices 300 and 400. The status management units 100b and 100c comprise the synchronous pair status management unit 100b managing each status by performing the above-mentioned synchronous data duplication processing and the asynchronous pair status management unit 100c managing each status by performing the above-mentioned asynchronous data duplication processing. These synchronous and asynchronous pair status management units 100b and 100c are the applications on the side of the host, and comprise the function of detecting each pair status of the primary storage device 200 and the first and second secondary storage devices 300 and 400.

In the present embodiment, the combination of the operation status (also simply referred to as “status” in the present embodiment) of two storage devices which are synchronously set in the synchronous data duplication processing is referred to as a “synchronous pair”. Also, the combination of the operation status of two storage devices which are asynchronously set in the asynchronous data duplication processing is referred to as an “asynchronous pair.” The operation status (status) referred here, for example, for a synchronous pair, indicates synchronously performing data copy and other types of processing and, for an asynchronous pair, indicates asynchronously performing data copy and other types of processing.

That is, the present embodiment refers to the status of the primary storage device 200 and the first secondary storage device 300 as “synchronous pair” because they are synchronously changed. On the other hand, the status of the first and second secondary storage devices 300 and 400 and the status of the primary storage device 200 and the second secondary storage device 400 are referred to as “asynchronous pair” as they are changed asynchronously. Note that the synchronous pair and the asynchronous pair respectively have the pair status management table.

Note that the present embodiment refers to the former in an asynchronous pair as a “first asynchronous pair” and the latter as a “second asynchronous pair.” The present embodiment also refers to the status of these synchronous pair and asynchronous pair as the “pair status,” and setting the pair status between synchronous pair or between asynchronous pairs is expressed as “pair creation” or simply as “creation.”

As the pair status, for example, the Duplex status, the Suspend status, [the] Copy [status], the Pair status, and Writable Suspend status (equivalent to the Susp(R) status) can be named. The Duplex status shows that the data stored in the respective volumes in both of the storage devices match each other. The Suspend status shows the status that the data copy processing between the above-mentioned synchronous pairs or between the asynchronous pairs is suspended. The Copy status shows the status that differential data between volumes is being copied and the completion of the copy is waited for. For example, when a synchronous pair is created, as the data is different in the primary volume 200a and the first secondary volume 300a, the data of the primary volume 200a is copied to the first secondary volume 300a, and the period since this copy processing is started until the processing is completed is equivalent to the relevant Copy status. Note that the status in which differential data is copied in accordance with the resync command, which is described later, in the Suspend status, is also the relevant Copy status. The Pair status shows the status in which the Copy status is completed. This Pair status shows that the data in the primary volume 200a and the data in the first secondary volume 300a match each other or that the data in the primary volume 200a and the data in the second secondary volume 400a match each other. If the data in the primary volume 200a is updated, the relevant updated data is copied to the secondary volumes 300a and 400a. The Writable Suspend status is basically the Suspend status and shows the status in which data can be written to the copy destination volume. Note that the Pair status is synonymous with the above-mentioned Duplex status.

In the present embodiment, the processor of the host computer 100 issues the resync command to the first and second secondary storage devices 300 and 400 with reference to the trigger that the respective status of the primary storage device 200 and the first secondary storage device 300 are both changed to Suspend status (or Writable Suspend status). That is, the processor makes the first and second secondary storage devices 300 and 400 perform the resync processing to be described later with reference to the relevant trigger.

As more specifically described, the synchronous pair status management unit 100b regularly acquires the respective status of the primary storage device 200 (primary volume 200a of the same) and the first secondary storage device 300 (the first secondary volume 300a of the same), and the input/output control unit 100a, in accordance with the above-mentioned trigger, copies the differential data between the copy data of the first secondary volume 300a and the second secondary volume 400a and transfers the data from the first secondary storage devices 300 to the second secondary storage device 400.

Configuration of Primary Storage Device

The primary storage device 200 comprises the primary volume 200a and the pair information management table 200d. The pair status management table 200d manages the pair attributes and the pair status related to the synchronous pair 200b and the asynchronous pair 200c. The details of the pair status management table 200d are described later.

Configuration of First Secondary Storage Device

The first secondary storage device 300 comprises the primary volume 300a and the pair status management table 300d. The pair status management table 300d manages the pair attributes and the pair status related to the synchronous pair 300b and the asynchronous pair 300c. The details of the pair status management table 300d are described later.

Configuration of Second Secondary Storage Device

The second secondary storage device 400 comprises the first secondary volume 400a and the pair status management table 400d. The pair status management table 400d manages the pair attributes and the pair status related to the asynchronous pair 400b and the asynchronous pair 400c. The details of this pair status management table 400d is described later.

(3) Storage System Operation Example

The storage system 1, by the above-mentioned configuration, performs the operations described below.

(3-1) Operational Modes

In the normal operation, the data stored in the primary volume 200a of the primary storage device 200 and the data stored in the first secondary volume 300a of the first secondary storage device 300 match each other (pair status: Duplex). In the host computer 100, the input/output control unit 100a issues a command to the relevant primary volume. The primary storage device 200 transfers the write data stored in the primary volume by the relevant command to the first secondary storage device 300 synchronously while the first secondary storage device 300 copies the relevant transferred write data to the first secondary volume 300a.

Furthermore, the primary storage device 200, in accordance with the above-mentioned command, transfers the write data stored in the primary volume to the second secondary storage device 400 asynchronously. The relevant second secondary storage device 400 copies the relevant transferred write data to the second secondary volume 400a.

On the other hand, between the first and second secondary storage devices 300 and 400, also, an asynchronous pair is created. The second asynchronous pair manages the differential data between the above-mentioned first and second secondary volumes 300a and 400a. The method of creating the relevant differential data is described later.

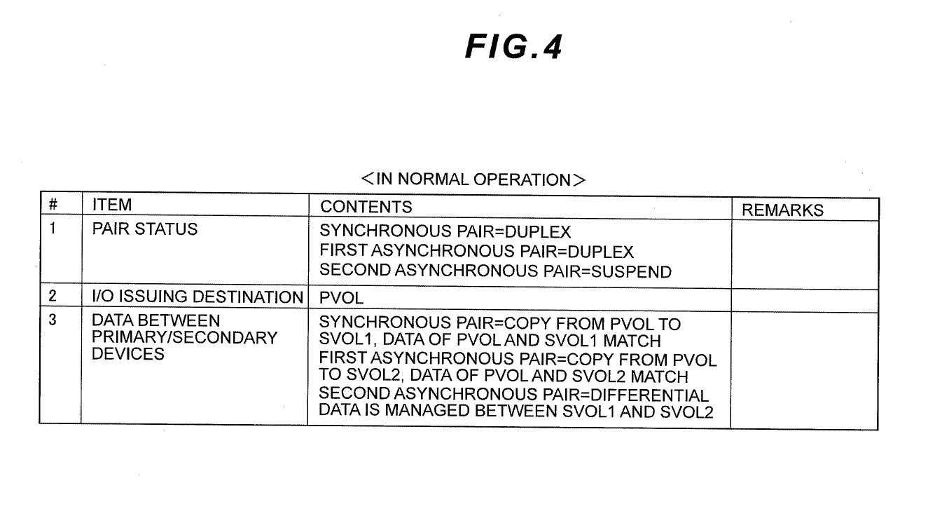

FIG. 4 is a diagram showing an operation example in each storage device during the normal operation. The relevant operation items can be classified into the pair status, the I/O issuing destination, and the data between the primary/secondary devices. The pair status shows the status of the synchronous pair and the first and second asynchronous pairs. The I/O issuing destination shows the issuing destination of the command (storage device of the same) which is, in the example by the figure, “PVOL (primary volume: PVOL).” Note that, if the I/O issuing destination is a secondary volume, in the figure, the first secondary volume is referred to as an “SVOL1 (first secondary storage device)” and the second secondary volume is referred to as an “SVOL2 (second secondary storage device).” The data between the primary/secondary devices indicates the data status between the respective storage devices. In the figure, the primary device indicates the primary storage device and the secondary device indicates the secondary storage device.

The data between the primary/secondary devices, for the synchronous pair (respective status of the primary storage device 200 and the first secondary storage device 300), shows that the data is copied from the primary volume 200a (PVOL) to the first secondary volume 300a (SVOL1) and that the data in the primary volume 200a and the data in the first secondary volume 300a match each other. For the first asynchronous pair, [the data between the primary/secondary devices] shows that the data is copied from the primary volume 200a to the second secondary volume 400a (SVOL2) and that the data in the primary volume 200a and the data in the second secondary volume 400a match each other. For the second asynchronous pair, [the data between the primary/secondary devices] shows that the differential data is managed between the first secondary volume 300a and the second secondary volume 400a.

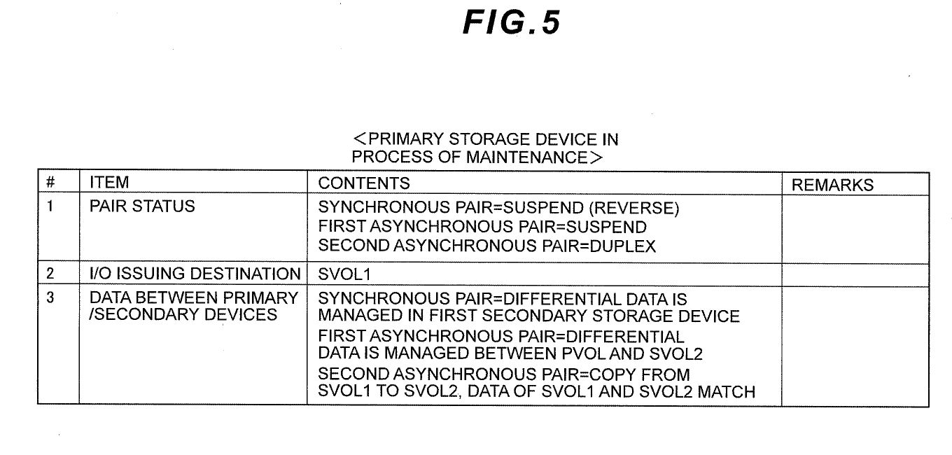

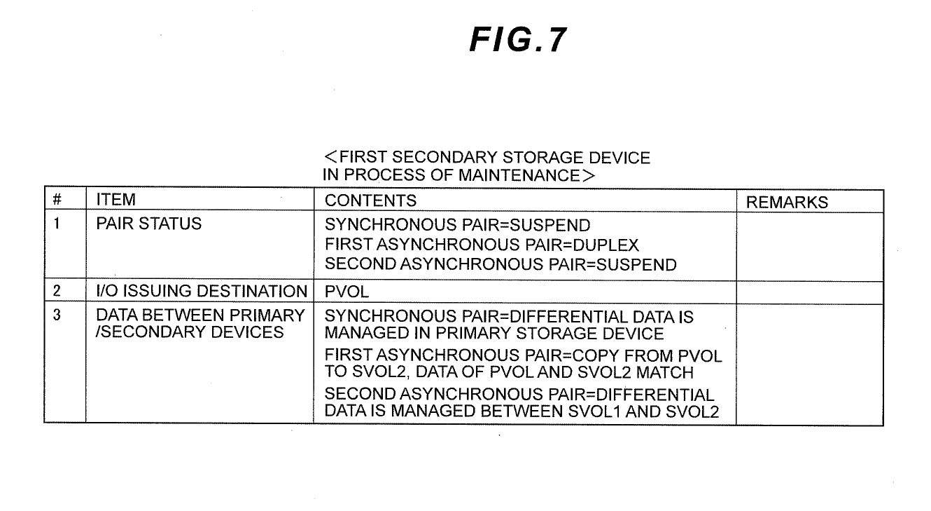

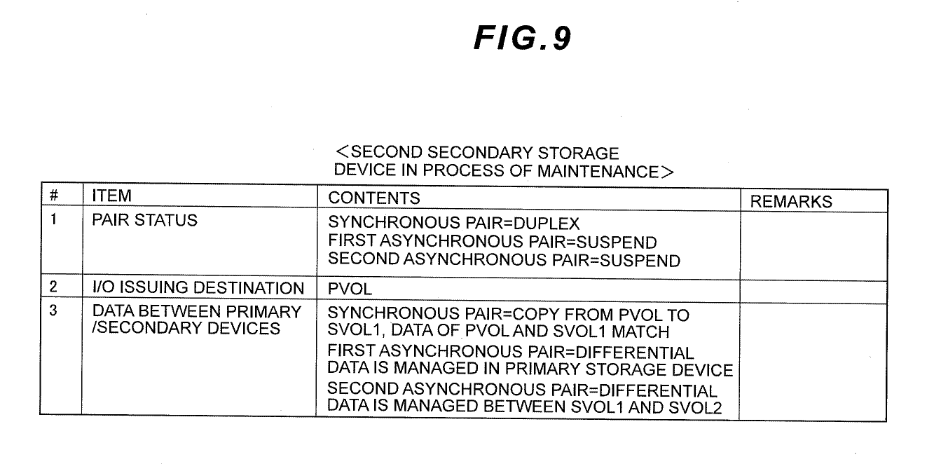

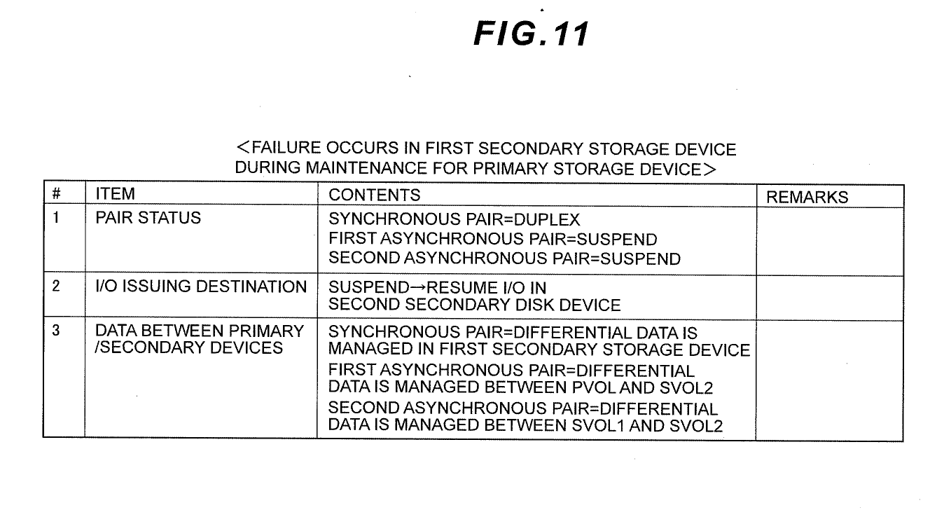

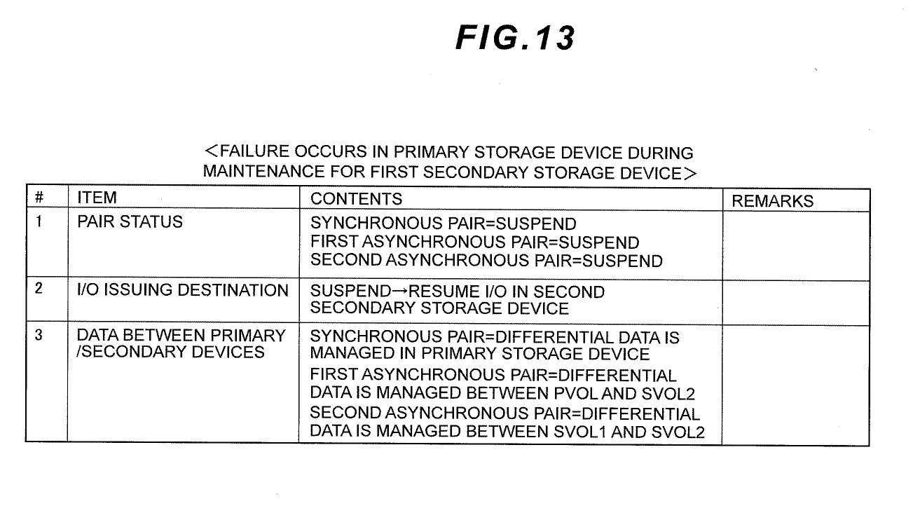

Note that the description related to each of these items can be applied almost in the same way to FIG. 5, FIG. 7, FIG. 9, FIG. 11, and FIG. 13, which are described later.

Maintenance for Primary Storage Device

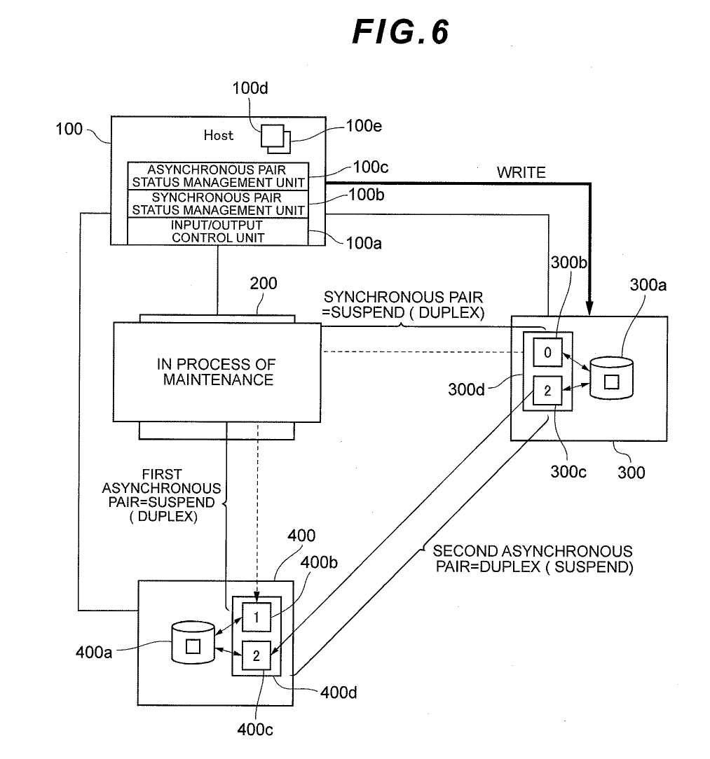

Both FIG. 5 and FIG. 6 are the diagrams showing an operation example of each storage device when the primary storage device is in process of maintenance. If the host computer 100 cannot use the primary storage device 200 due to maintenance or for other reasons, in accordance with the operation by the administrator or others, the host computer 100 changes the status of the synchronous pair 300b of the first secondary volume 300a to the “Writable Suspend status (Suspend (Reverse) status shown in the figure)”, as shown in FIG. 5, and issues the command to the first secondary storage device 300. Note that the present embodiment also refers to the relevant status in the abbreviated form “Susp(R).”

As shown in FIG. 6, for the write data transferred to the first secondary storage device 300 by the issuance of the relevant command, in accordance with the respective status of the synchronous pair 300b and the second asynchronous pair 300c, the differential data is management in the first secondary storage device 300. At this time, the asynchronous pair status management unit 100c instructs the resync processing by issuing the command for performing resync (resync command) to the first secondary storage device 300 (second asynchronous pair 300c of the same) when detecting that the synchronous pair 300b is in the Suspend status.

If the resync processing is instructed for the first secondary storage device 300 (second asynchronous pair 300c of the same), the differential data between the first and second secondary storage devices 300 and 400 is copied to the second secondary volume 400a. In other cases, if the resync processing is performed for the second secondary volume 300a, the first asynchronous pair is changed to the Suspend status instead, and the differential data between the first and second secondary volumes 300a and 300b is managed.

Maintenance for First Secondary Storage Device

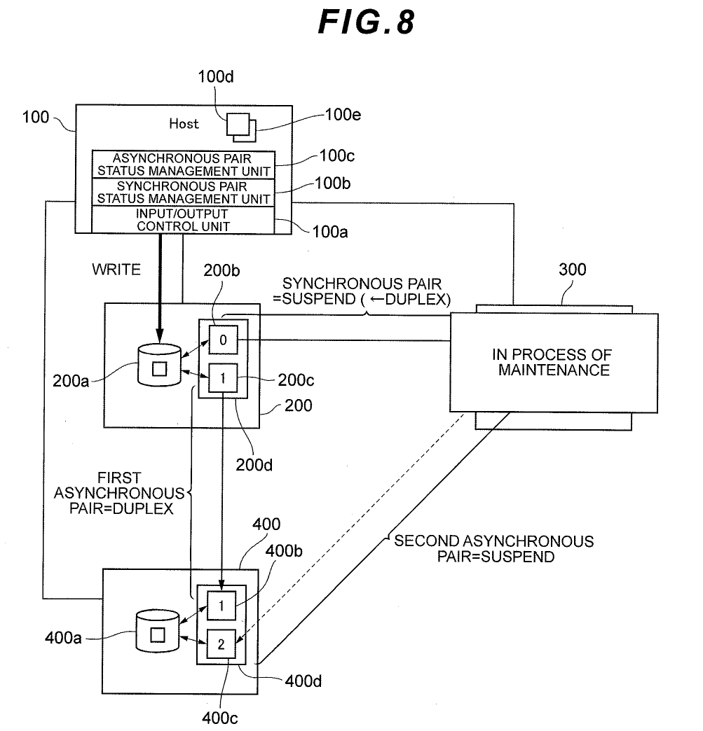

Both FIG. 7 and FIG. 8 are the diagrams showing an operation example of each storage device when the first secondary storage device 300 is in process of maintenance. In performing maintenance for the first secondary storage device 300, in accordance with the operation by the administrator or others, the pair status of the primary volume 200a and the first secondary volume 300a is changed to the Suspend status. A command is issued to the primary storage device 200 and, for the write data transferred to the primary storage device 200 by the relevant command, the differential data is managed in the primary storage device 200. In this case, the data is not copied to the first secondary storage device 300. Note that, for the first asynchronous pair, the pair status maintains the Duplex status. The write data transferred to the primary storage device 200 is also copied to the second secondary storage device 400. As for the second asynchronous pair, also, the Suspend status is maintained and the differential data between the first secondary storage device 300 and the second secondary storage device 400 is managed.

Maintenance for Second Secondary Storage Device

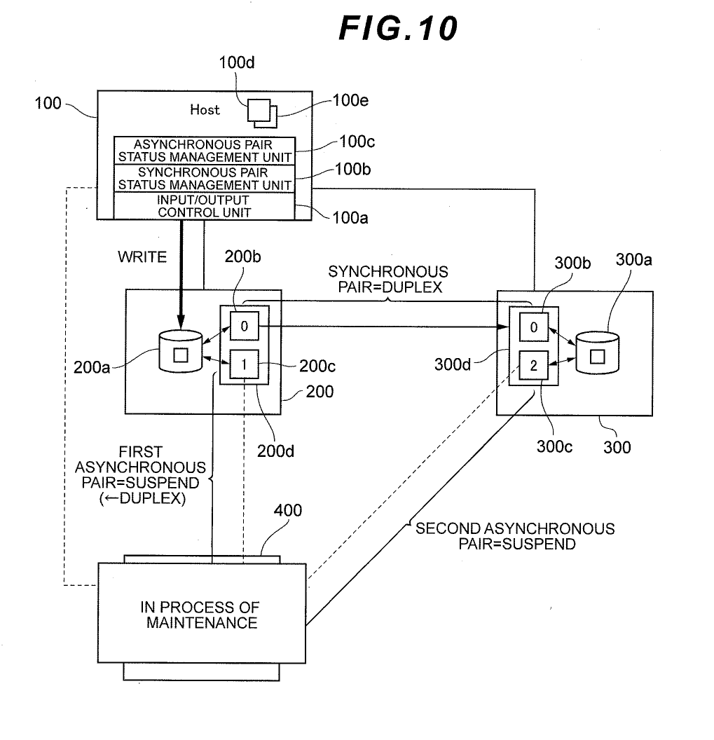

Both FIG. 9 and FIG. 10 are the diagrams showing an operation example of each storage device when the second secondary storage device 400 is in process of maintenance. In performing maintenance for the second secondary storage device 400, the asynchronous pair management unit 100c, in accordance with the operation by the administrator or others, sets the pair status of the asynchronous pair between the primary storage device 200 and the second secondary storage device 400 to the Suspend status. Then, a specific command is issued to the primary storage device 200, and the write data transferred to the primary storage device 200 by the relevant command is copied to the first secondary storage device 300. By the first asynchronous pair between the primary storage device 200 and the second secondary storage device 400, the data is not copied to the second secondary storage device 400, the differential data is managed. For the second asynchronous pair, the Suspend status is maintained, and the differential data between the first and second secondary storage devices 300 and 400 is managed.

Failure Occurs in First Secondary Storage Device during Maintenance of Primary Storage Device

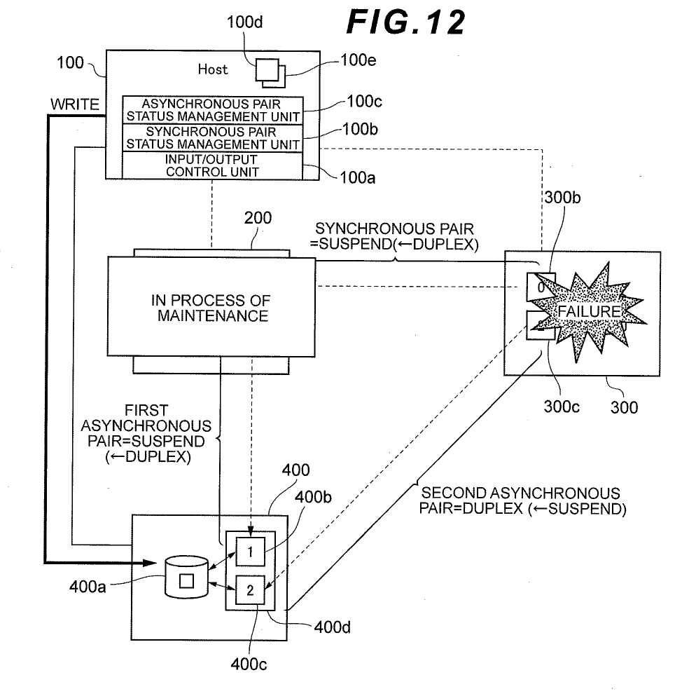

Both FIG. 11 and FIG. 12 are the diagrams showing an operation example in case a failure occurs in the first secondary storage device 300 when the primary storage device 200 is in process of maintenance.

If the primary storage device 200 is in process of maintenance, the write data received by the first secondary storage device 300 from the host computer 100 is, according to the setting of the second asynchronous pair shown in FIG. 11, copied from the first secondary storage device 300 to the second secondary storage device 400 as shown in FIG. 12. Therefore, even if a failure occurs in the first secondary storage device 300 when the primary storage device 200 is in process of maintenance, as the data copied to the second secondary storage device 400 exists, the data is not lost. Furthermore, the host computer 100, by issuing a command to the second secondary storage device 400, can resume the input/output of the suspended data.

Failure Occurs in Primary Storage Device during Maintenance of First Secondary Storage Device

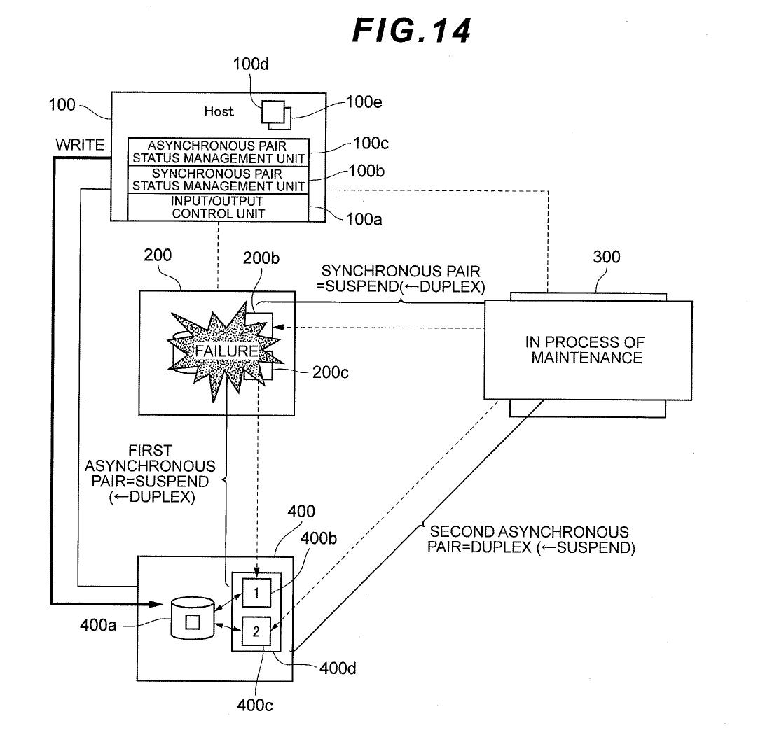

Both FIG. 13 and FIG. 14 are the diagrams showing an operation example in case a failure occurs in the primary storage device 200 when the first secondary storage device 300 is in process of maintenance. The write data received by the primary storage device 200 from the host computer 100 when the first secondary storage device 300 is in process of maintenance is, according to the first asynchronous pair shown in FIG. 13, copied from the primary storage device 200 to the second secondary storage device 400 as shown in FIG. 14.

Therefore, even if a failure occurs in the primary storage device 200 when the first secondary storage device 300 is in process of maintenance, as the data copied to the second secondary storage device 400 exists, the data is not lost. Furthermore, the host computer 100, by issuing a command to the second secondary storage device 400, can resume the input/output of the suspended data.

(3-2) Update Status of Pair Status

Before Pair Creation

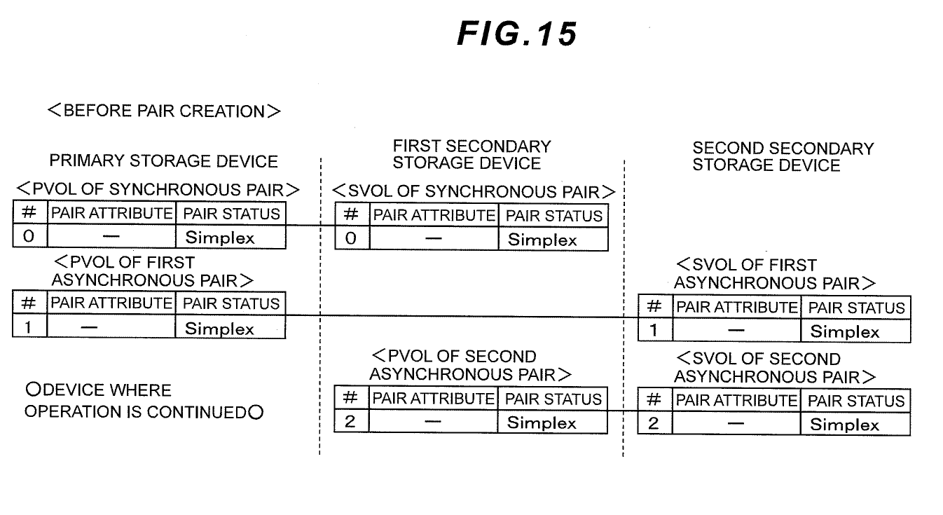

FIG. 15 is a diagram showing the status before a synchronous pair is created in the pair status management table. FIG. 15 shows the configuration examples of, from left, the pair status management tables 200d, 300d, and 400d, of the primary storage device 200a and the first and second secondary storage devices 300 and 400. Note that, in the present embodiment, including the figures, the sign “#” indicates an address.

The pair status management table 200d of the primary storage device 200 manages the pair attribute and the pair status related to the primary volumes of the synchronous pair and the first asynchronous pair. The pair attribute shows whether the relevant volume is a primary volume or a secondary volume. On the other hand, the pair status, as mentioned above, shows the status of the volumes of both of the storage devices configuring the pair.

In the pair status management table 200d of the primary storage device 200 shown on the left in the figure, the address “0” shows the primary volume of the synchronous pair, and the address “1” shows the primary volume of the first asynchronous pair. Note that, in this status, the host computer 100 continues the operation by using the primary storage device 200.

In the pair status management table 300d of the first secondary storage device 300 shown on the center in the figure, the address “0” shows the first secondary volume 300a of the synchronous pair, and the address “2” shows primary volume 200a of the second asynchronous pair.

In the pair status management table 400d of the second secondary storage device 400 shown on the right in the figure, the address “0” shows the first secondary volume 300a of the first asynchronous pair, and the address “1” shows the second secondary volume 400a of the second asynchronous pair.

In the respective pair status management tables of the primary storage device 200 and the first and second secondary storage devices 300 and 400 shown in FIG. 15, as the pair status is not set yet, each pair status is set as the “Simplex status.”

Creating Synchronous Pair

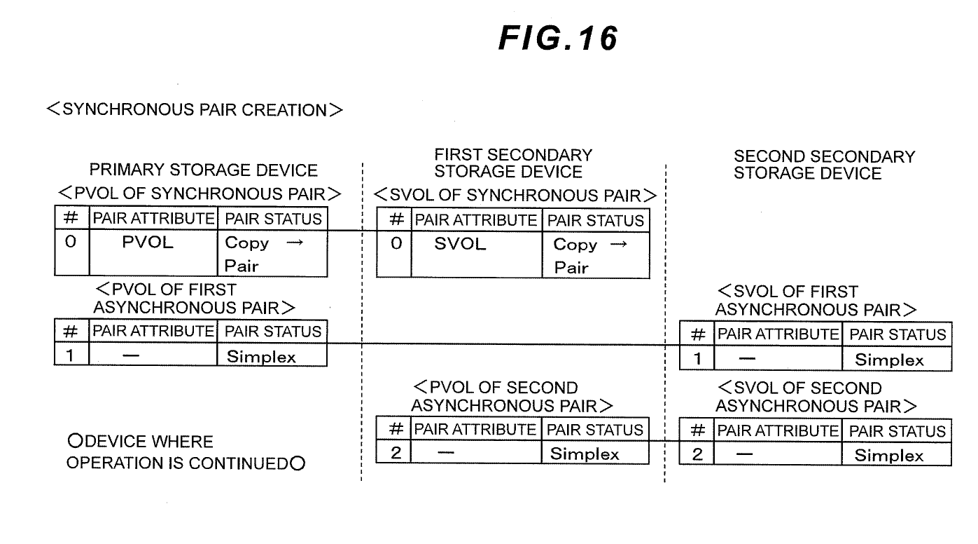

FIG. 16 is a diagram showing an example where a synchronous pair is created in the pair status management table. The latest data is managed by the primary storage device 200 and the data is being copied to the first secondary storage device 300. In this status, the host computer 100 continues the operation by using the primary storage device 200.

In the relevant FIG. 16, for the synchronous pair, the pair attribute and the pair status are set for the primary volume 200a and the first secondary volume 300a. As more specifically described, for the primary volume 200a of the synchronous pair, the pair attribute is set to “PVOL (primary volume),” and the pair status is set to “Copy” and “Pair.” On the other hand, for the first secondary volume 300a of the synchronous pair, the pair attribute is set to “SVOL (secondary volume),” and the pair status is set to “Copy” and “Pair.”

By this type of setting, the data stored in the primary volume 200a of the primary storage device 200 is copied and transferred to the first secondary volume 300a of the first secondary storage device 300.

Creating First Asynchronous Pair

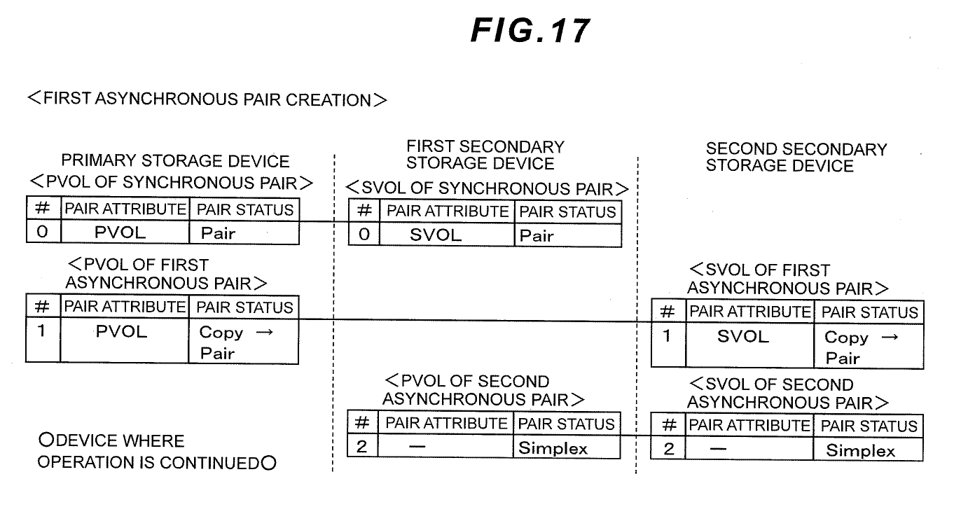

FIG. 17 is a diagram showing an example where a first asynchronous pair is created in the pair status management table. In the setting shown by FIG. 17, the creation of the above-mentioned synchronous pair is completed, and the latest data is supposed to be stored in the primary storage device 200 and the first secondary volume 300a.

In the relevant FIG. 17, for the first asynchronous pair, the pair attribute and the pair status are set for the primary volume 200a and the second secondary volume 400a. As more specifically described, for the primary volume 200a of the first asynchronous pair, the pair attribute is set to “PVOL (primary volume),” and the pair status is set to “Copy” and “Pair.” On the other hand, for the first secondary volume 300a of the first asynchronous pair, the pair attribute is set to “SVOL (secondary volume),” and the pair status is set to “Copy” and “Pair.”

By this type of setting, the latest data is stored in the primary volume 200a of the primary storage device 200 and in the second secondary volume 400a of the second secondary storage device 400.

Creating Second Asynchronous Pair

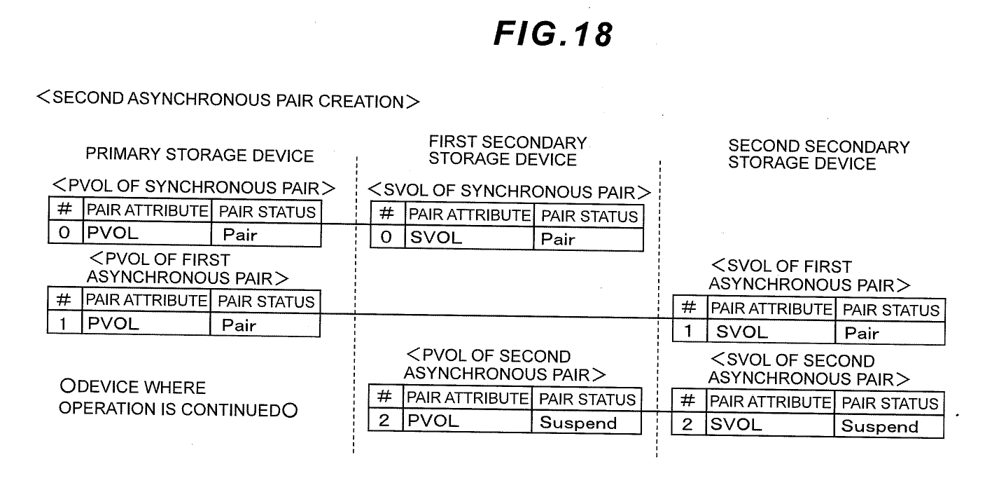

FIG. 18 is a diagram showing an example where a first asynchronous pair is created in the pair status management table. In the setting shown by FIG. 17, after creating the above-mentioned first synchronous pair, the second asynchronous pair is created and is set to the normal operation mode so that the latest data will be stored in the primary storage device 200 and the first secondary volume 300a.

In the relevant FIG. 18, for the first asynchronous pair, the pair attribute and the pair status are set for the primary volume 200a and the second secondary volume 400a are set and, for the second asynchronous pair, the pair attribute and the pair status of the first secondary volume 300a and the second secondary volume 400a are set.

As more specifically described, for the primary volume 200a of the first asynchronous pair, the pair attribute is set to “PVOL (primary volume),” and the pair status is set to “Copy.” For the second secondary volume 400a of the first asynchronous pair, the pair attribute is set to “SVOL” and the pair status is set to “Pair.” On the other hand, for the first secondary volume 300a of the second asynchronous pair, the pair status is set to “PVOL” and the pair status is set to “Suspend.” For the second secondary volume 400a of the second asynchronous pair, the pair status is set to “SVOL,” the pair attribute is set to “SVOL” and the pair status is set to “Suspend.”

By this type of setting, the storage system 1 is set to normal operation mode, and the latest data is stored in the primary volume 200a and the first secondary volume 300a. Note that this storage system 1 is, though copy is asynchronous, by the asynchronous pair, the latest data is stored in the primary volume 200a and also in the second secondary volume 400a.

Maintenance for Primary Storage Device

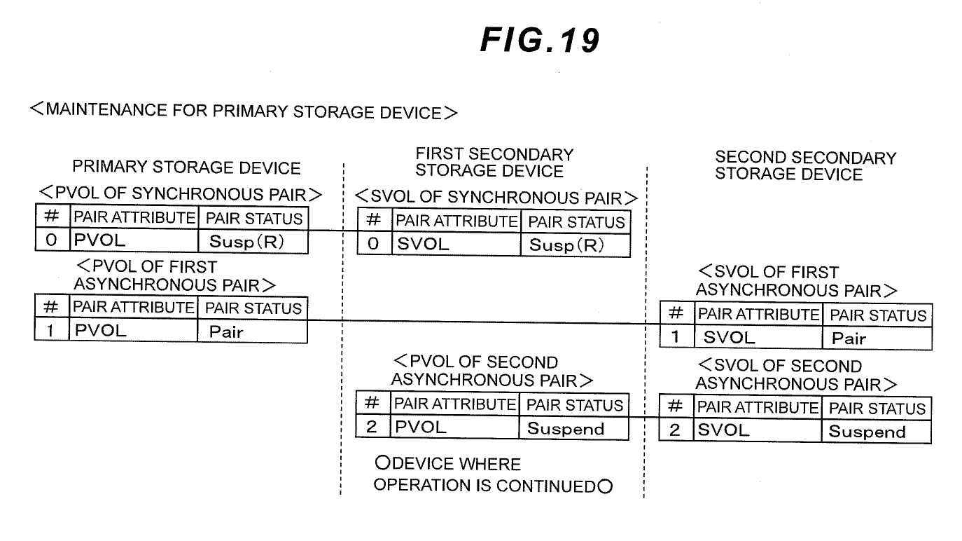

FIGS. 19 to 21 are the diagrams showing the status of the pair status management table when maintenance is performed for the primary storage device 200. In the status shown in FIG. 19, the host computer 100 changes the synchronous pair for maintaining the primary storage device 200 to the Suspend status, and continues the operation by the first secondary storage device 300.

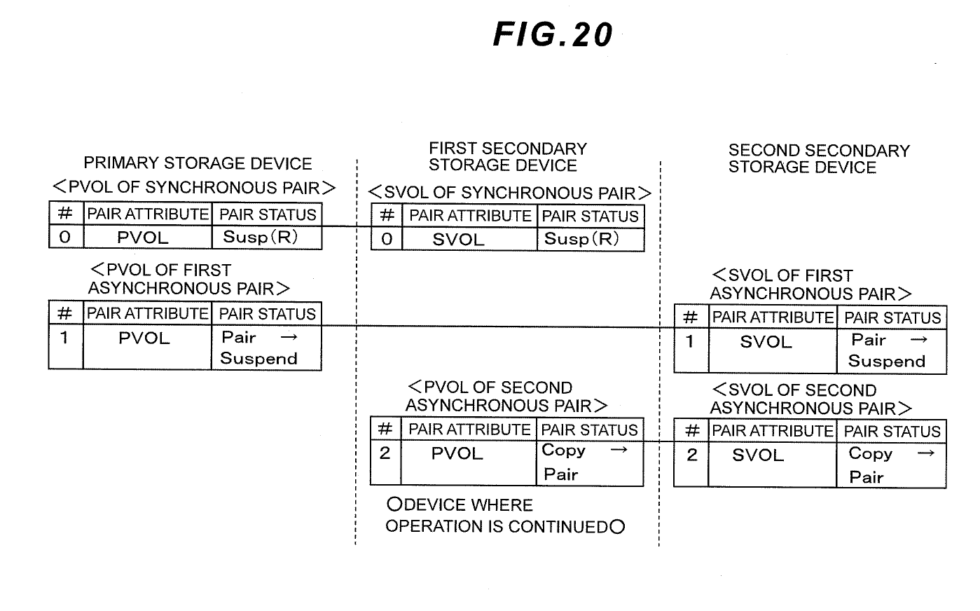

In the status shown in FIG. 20, the host computer 100, detecting the Suspend status of the synchronous pair, changes the second asynchronous pair to the Resync status by the above-mentioned application in collaboration with the primary storage device 200 and automatically changes the first asynchronous pair to the Suspend status while the data is originally copied to the second secondary storage device 400 by the first asynchronous pair, and therefore, the data in the second secondary storage device 400 becomes nearly the latest.

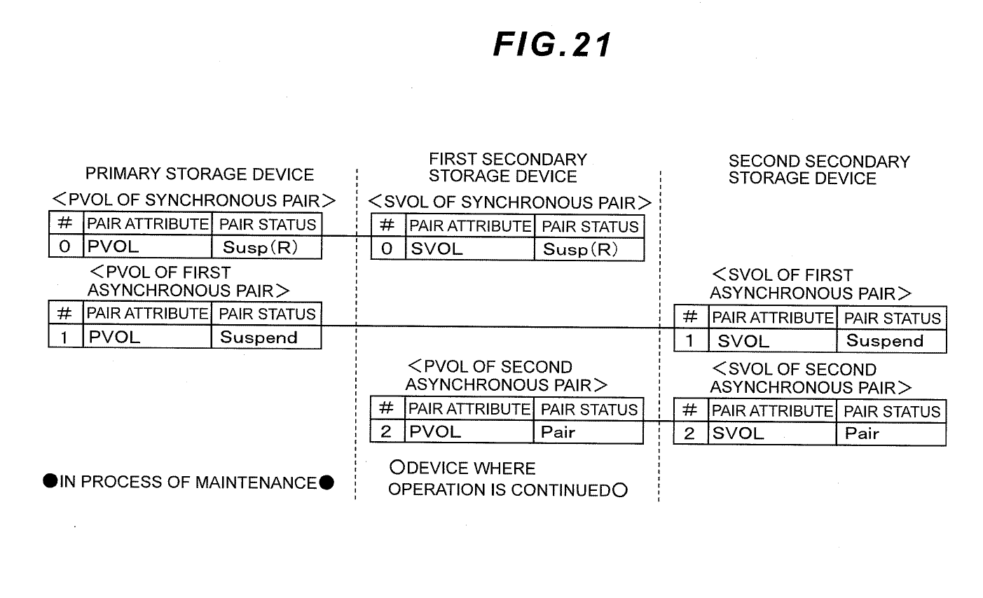

In the status shown in FIG. 21, maintenance for the primary storage device 200 is performed. By the second asynchronous pair set by the processor of the host computer 100, nearly the latest data is stored in the second secondary storage device 400.

Failure Occurs in First Secondary Storage Device during Maintenance of Primary Storage Device

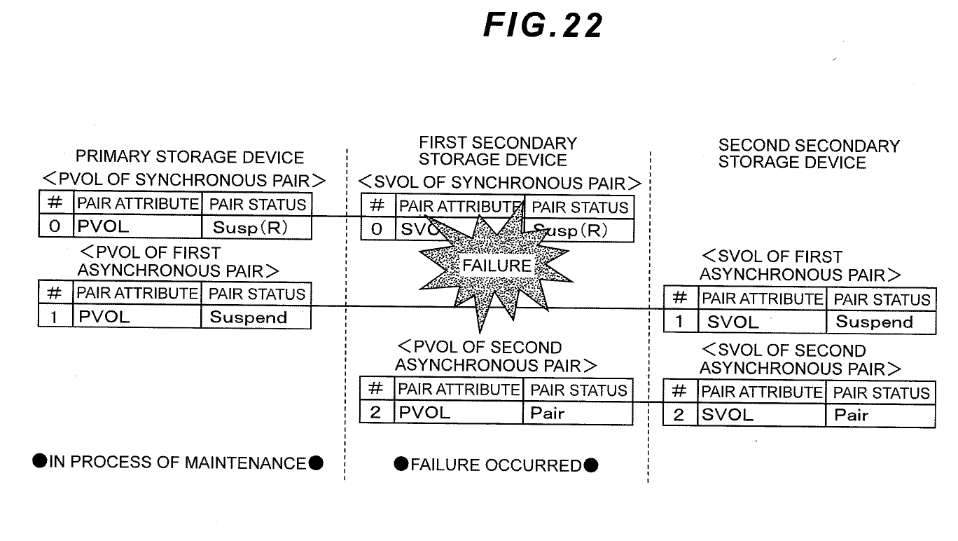

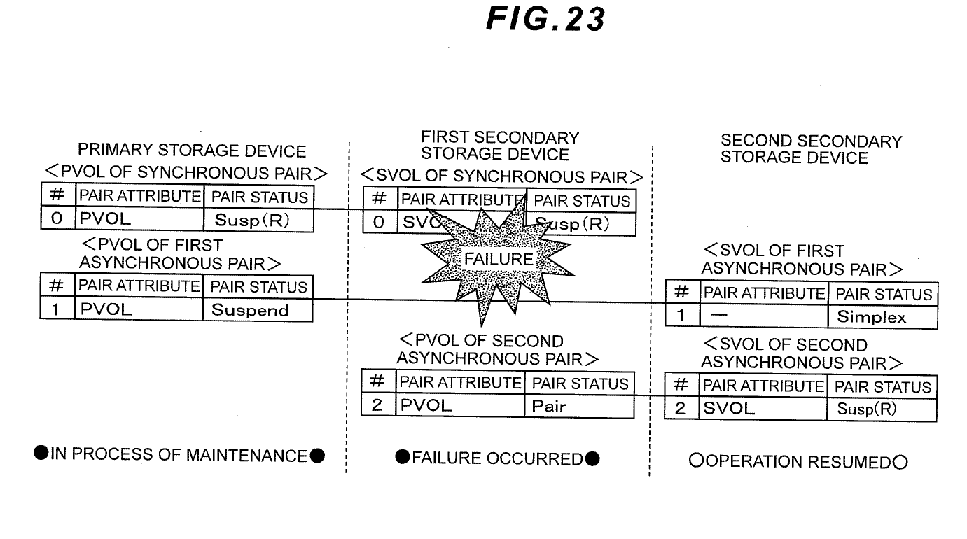

Both FIG. 22 and FIG. 23 are the diagrams showing the status of the pair status management table in case a failure occurs in the first secondary storage device 300 when the primary storage device 200 is in process of maintenance. The status shown in FIG. 22 shows the status in which a failure occurs in the first secondary storage device 300 when the primary storage device 200 is in process of maintenance and input/output is suspended. The status shown in FIG. 23 shows the status in which the host computer 100 resumes input/output by using nearly the latest data stored in the second secondary storage device 400. As more specifically described, the first asynchronous pair is deleted, and the second asynchronous pair is in the Writable Suspend status (equivalent to “Susp(R)” shown in the figure).

Failure Occurs in Primary Storage Device during Normal Operation

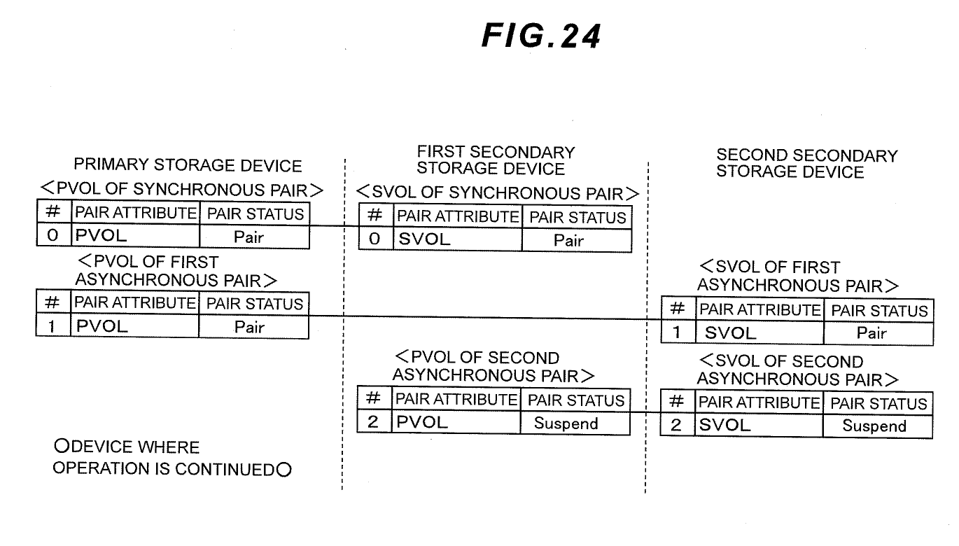

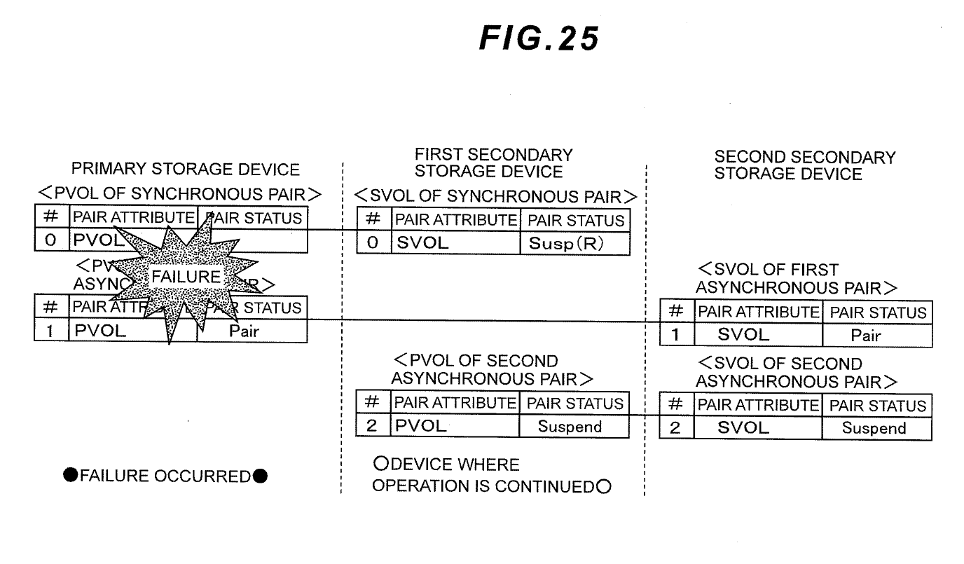

FIGS. 24 to 26 are the diagrams showing the status of the pair status management table when a failure occurs in the primary storage device 200 during the normal operation. The status shown in FIG. 24 shows the status of the pair status management table in the normal operation. In the status shown in FIG. 25, a failure occurs in the primary storage device 200 and the first secondary volume 300a of the synchronous pair is changed to the Writable Suspend status so that input/output will be continued by the first secondary storage device 300.

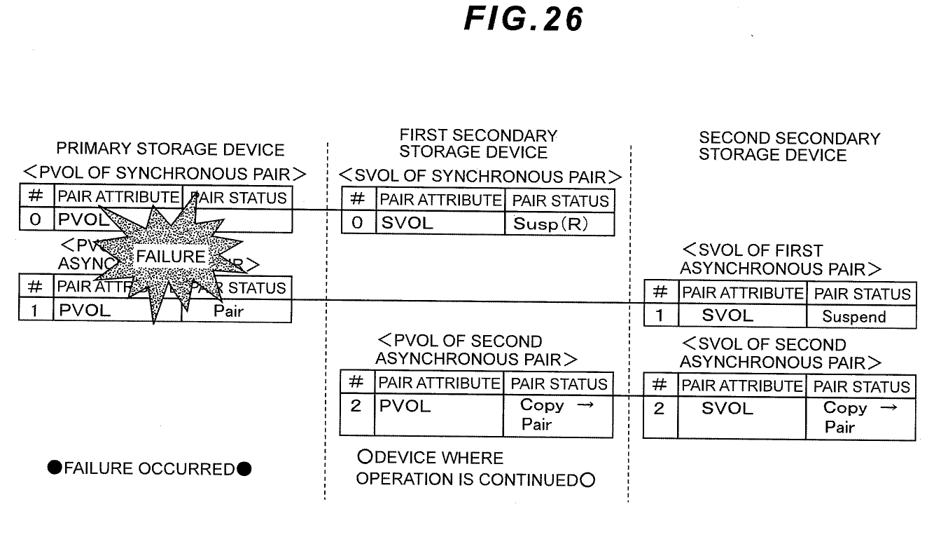

In the status shown in FIG. 26, the host computer 100, detecting the Suspend status of the synchronous pair, changes the second asynchronous pair to the Resync status by the application in collaboration with the storage device and automatically changes the first asynchronous pair to the Suspend status while the data is duplicated by the second asynchronous pair. Even if a failure occurs in the first secondary storage device 300 later, nearly the latest data is stored in the second secondary storage device 400.

(3-3) Resync Processing

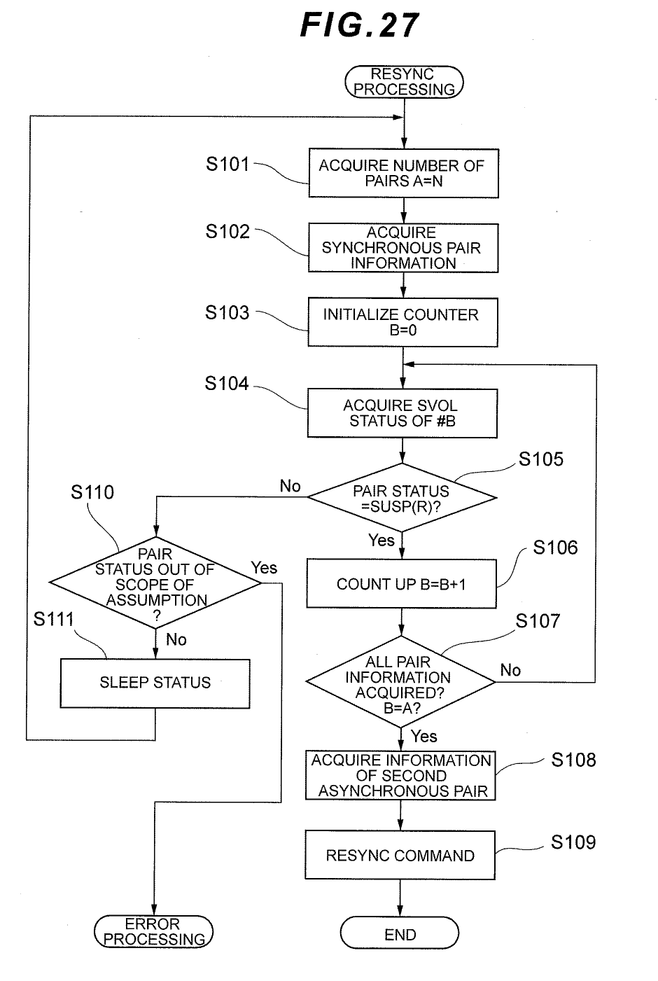

FIG. 27 is a flowchart showing an example of the procedure in the resync processing. Each procedure shown in the figure is performed by the processor of the host computer 100.

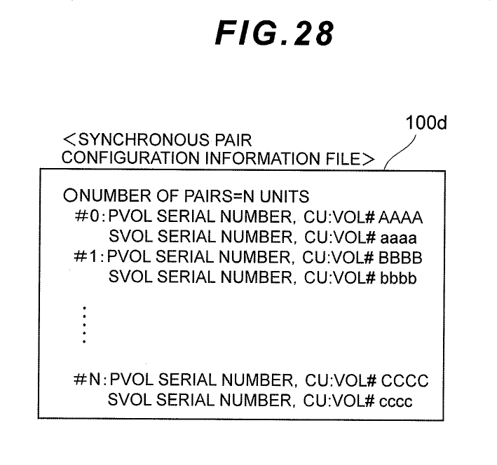

At the step S101, the processor of the host computer 100 acquires the number A (=N units) of the pairs from the configuration information file of a synchronous pair which is shown in FIG. 28. At the step S102, the processor acquires the synchronous pair information from the synchronous pair configuration information file 100d shown in FIG. 28. The synchronous pair information includes the serial number of the primary storage device and other types of information.

At the step S103 shown in FIG. 27, the processor initializes the counter and sets the address variable B equal to 0. At the step S104, the processor acquires the status of the secondary volume (SVOL) corresponding with the address shown by the address variable B in the relevant synchronous pair information. Note that, in the present embodiment, as mentioned above, the sign “#” indicates the address. The processor, to the first secondary storage device 300, issues a command related to the status to which the relevant secondary volume must be changed (e.g. “Susp(R)”).

At the step S105, the processor confirms whether the pair status is Writable Suspend (“Susp(R)”) or not. If the pair status is Writable Suspend, the processor performs the following step S106.

At the step S106, the processor counts up the address variable B by 1. At the step S107, the processor determines whether all the pair information is acquired or not and, if not acquired, returns to the above-mentioned step S104 while, if all the information is acquired, performs the step S108 described below.

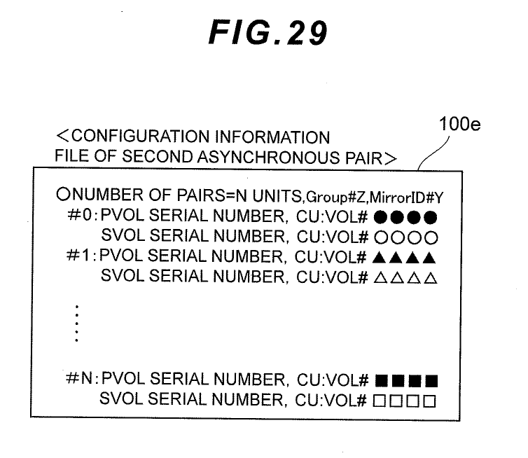

At the step S108, the processor acquires the second asynchronous pair information from the configuration information file of the second asynchronous pair shown in FIG. 29. At the step S109 shown in FIG. 27, the processor, to the first secondary storage device 300, issues a command that resync must be performed (resync command).

On the other hand, if the pair status is not Writable Suspend at the step S105 mentioned above, the processor determines whether the above-mentioned pair status is out of the scope of the assumption or not (step S110). The processor, if the pair status is not out of the scope of the assumption, changes the status transit to Sleep, and returns to the above-mentioned step S101 and, if the pair status is out of the scope of the assumption, performs the error processing. The processor, as this error processing, for example, if information cannot be acquired due to the path failure between the host computer 100 and the disk controller, creates the signal for displaying error messages to the user.

Status Acquisition Processing in First Secondary Storage Device

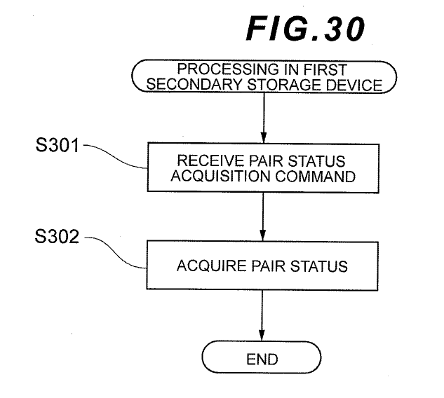

FIG. 30 is a flowchart showing an operation example in the first secondary storage device 300. In this flowchart, the processor of the first secondary storage device 300 performs the processing for acquiring the pair status of the first secondary storage device 300 (equivalent to the SVOL shown in the figure) of the synchronous pair. The relevant processor, basically, from the input/output control unit 100a which is one of the host applications of the host computer 100, reports the pair status of the CU: VOL# specified by the input interface to the status management units 100b and 100c. This is a flowchart showing an example of the procedure in the processing if the first secondary storage device 300 receives a status acquisition command from the host computer 100.

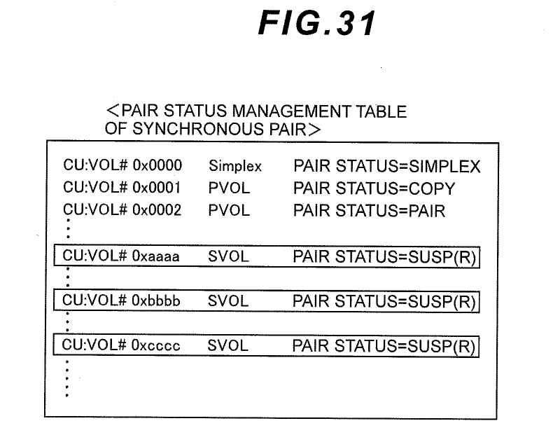

At the step S301, the processor of the first secondary storage device 300 receives a pair status acquisition command from the host computer 100. At the step S302, the processor acquires the pair status from the pair status management table of the synchronous pair shown in FIG. 31. The relevant synchronous pair, in units of CU [symbol] VOL shown in the figure, comprises the pair status management table as a table for managing the pair status.

The processor acquires the pair status of the specified CU: VOL# from the synchronous pair status management unit 100b and reports the status to the host computer 100. The processor comprises, as the contents of this report, both the interface for reporting per pair and the interface for reporting in units of multiple pairs.

Resync Processing for Asynchronous Pair 2

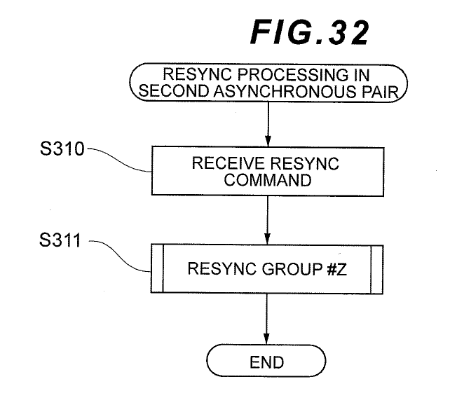

FIG. 32 is a flowchart showing an example of the procedure in the resync processing for the second asynchronous pair. The procedure shown in the figure shows the procedure performed by the processor of the first secondary storage device 300.

At the step S310, the relevant processor, from the input/output control unit 100a which is one of the host applications, receives a command for performing resync for the second asynchronous pair with the group# and the mirror ID# as the input interface. At the step S311, the relevant processor performs the resync processing by specifying the relevant group# included in the relevant command. The detailed procedure of the step S311 is described later.

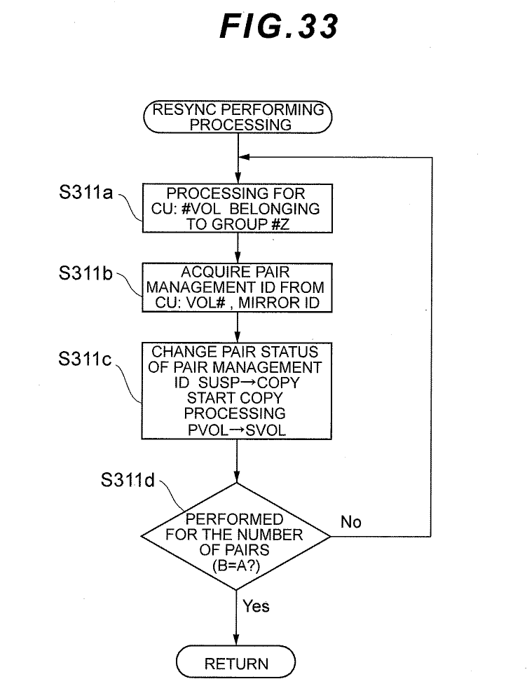

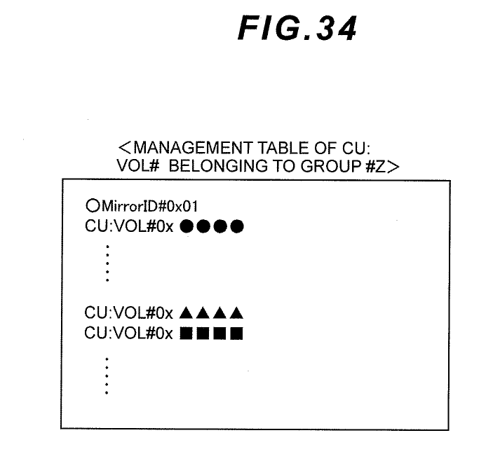

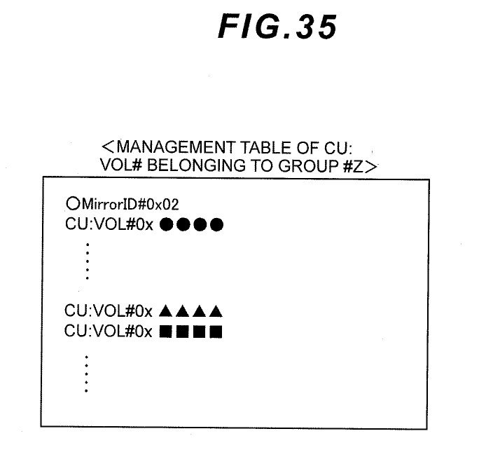

FIG. 33 is a flowchart showing the detailed contents of the resync processing (step S311) shown in FIG. 32. At the step S311a, the processor acquires the CU: VOL# belonging to the group#Z. Then the processor can acquire the management table including the contents shown in FIG. 34 and FIG. 35. In the relevant management table, the CU: VOL# belonging to the group# is managed. The management table shown in FIG. 34 corresponds with the mirror ID#0×01, and the management table shown in FIG. 35 corresponds with the mirror ID#0×02.

In this situation, as for the first secondary storage device 300 only, the type of asynchronous pair is only the primary volume (PVOL) of the second asynchronous pair but, for example, the second secondary storage device 400 has the configuration in which the first asynchronous pair and the second asynchronous pair share the same secondary volume 400a. As just described, even in the case of the similar secondary volumes, the pair status of the secondary volume of the first asynchronous pair and the pair status of the secondary volume of the second asynchronous pair are separately managed, and therefore, the present embodiment distinguishes respective volumes by mirror IDs (Mirror IDs).

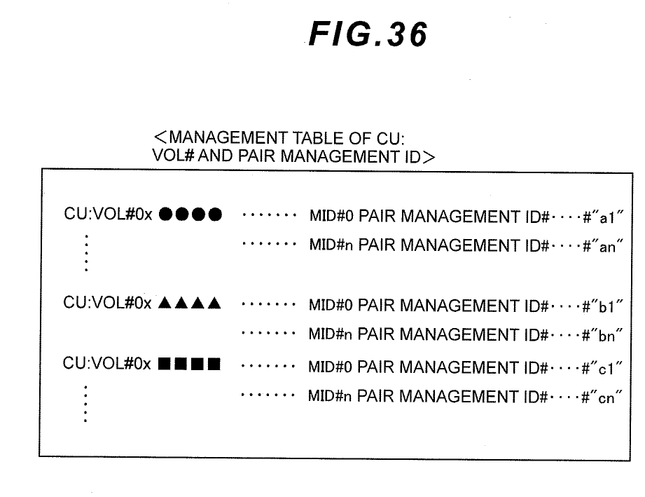

Next, at the step S311b shown in FIG. 33, the relevant processor acquires the pair management ID from the CU: VOL# and the mirror ID (equivalent to the Mirror ID shown in the figure). The relevant acquired pair management ID, if shown in the figure, becomes the contents of the management table shown in FIG. 36. In the relevant management table, CU: VOL# and the pair management IDs are associated and managed.

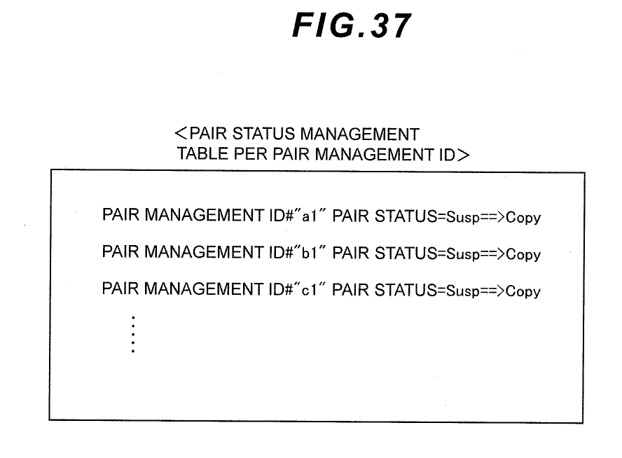

At the step S311c shown in FIG. 33, the relevant processor, as shown in FIG. 37, changes the pair status corresponding with the pair management ID# from the “Suspend status” to the “Copy status,” and performs the copy processing from the primary volume to the secondary volume. The management table shown in FIG. 37 is the table for managing the pair status of each pair management ID. Note that, for the synchronous pair is managed so that the CU: VOL# and the pair status will remain 1:1 while, for the asynchronous pair, as multiple asynchronous pair status is managed by one CU: VOL#, the pair management IDs are used to be 1:1 with the pair status.

At the step S311d, the processor confirms whether the above steps S311a to 311c were performed for the number of pairs or not and, if not, returns to the step S311a and perform the processing repeatedly while, if the processing was performed for the number of pairs, the processing is completed.

Processing for Returning from Resync Status to Normal Status

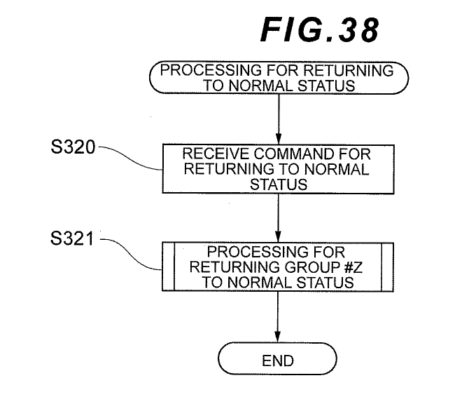

FIG. 38 is a flowchart showing an example of the processing for returning to the normal status. The procedure shown in the figure shows the procedure performed by the processor of the first secondary storage device 300. At the step S320, the relevant processor, from the input/output control unit 100a which is one of the host applications, receives a command for returning the second asynchronous pair to the normal status with the group# and the mirror ID# as the input interface. At the step S321, the relevant processor performs the processing of specifying the relevant group# included in the relevant command and returning [the pair] to the normal status. The detailed procedure of the step S321 is described later.

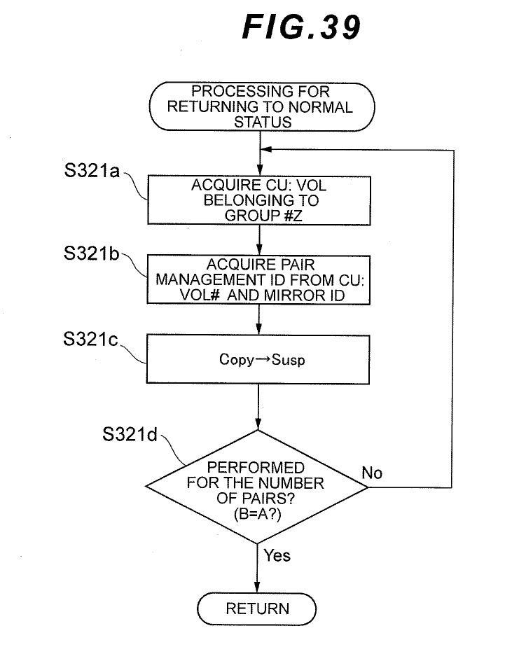

FIG. 39 is a flowchart showing the detailed contents of the processing (step S321) for returning [the pair] to the normal status as shown in FIG. 38. At the step S321a, the processor acquires the CU: VOL# belonging to the group#Z and acquires the management table including the CU: VOL# belonging to the group#. Next, at the step S321b shown in FIG. 39, the relevant processor acquires the pair management ID from the CU: VOL# and the mirror ID (equivalent to the Mirror ID shown in the figure).

At the step S321c, the relevant processor changes the pair status corresponding with the pair management ID# from the “Copy status” to the “Writable Suspend status (Susp(R)),” and suspends the copy processing from the primary volume (PVOL) of the primary storage device to the secondary volume (SVOL) of the secondary storage device. At the step S321d, the processor confirms whether the above-mentioned steps S321a to 321c were performed for the number of pairs or not and, if not, returns to the step S321a and perform the processing repeatedly while, if the processing was performed for the number of pairs, the processing is completed.

Copying Differential Data in Resync Operation

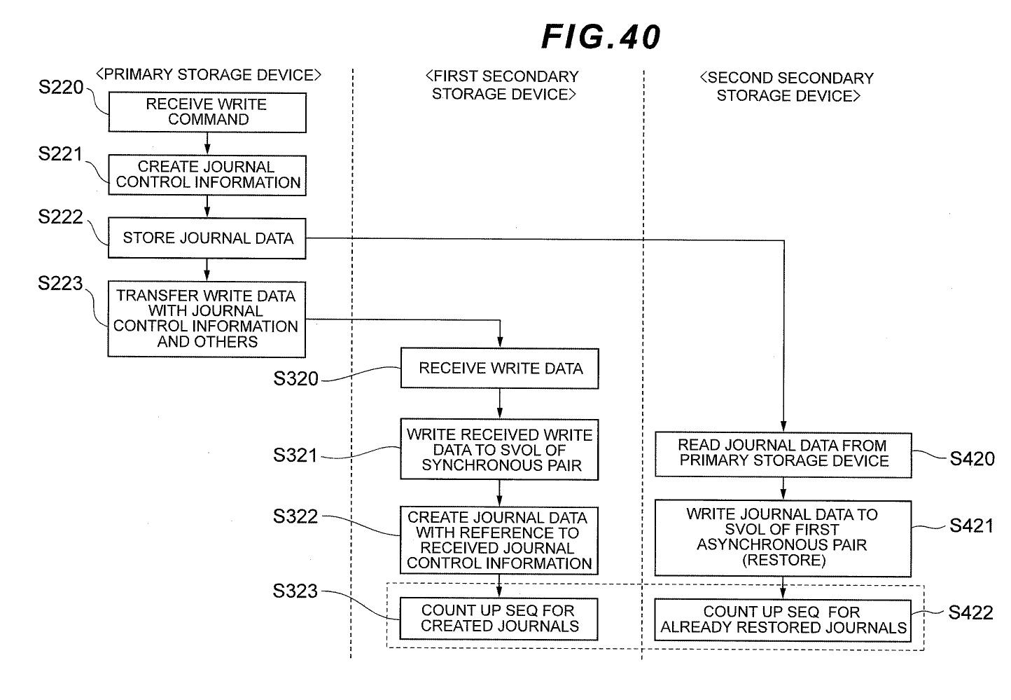

FIG. 40 is a flowchart showing an example of the procedure in the differential data copy method in the resync processing. The following is the supplementary description of the management number of already created journals (hereinafter abbreviated as the “SEQ”) and the SEQ# of already restored journals. FIG. 40 shows the processing in the primary storage device 200 on the left, the processing in the first secondary storage device 300 on the center, and the processing in the second secondary storage device 400 on the right.

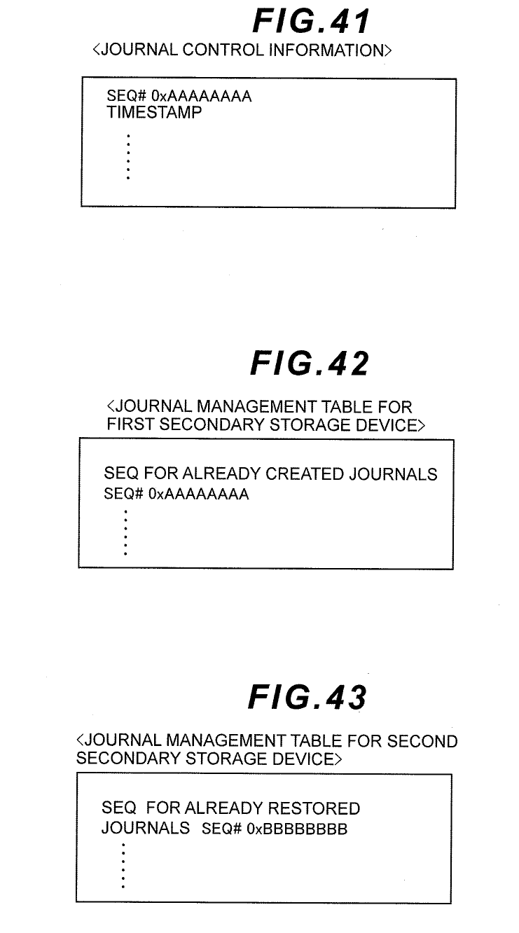

In the normal operation, the primary storage device 200, receiving a write command from the host computer 100 (step S220), performs the synchronous data copy to the first secondary storage device 300 and the asynchronous data copy to the second secondary storage device 400. The primary storage device 200 creates the journal control information (equivalent to the JNL control information shown in the figure) (step S221), and stores the journal data (JNL data shown in the figure) (step S222). This journal control information, as shown in FIG. 41, for example, includes the SEQ# and the timestamp. The primary storage device 200 gives the relevant journal control information and others to the transfer target write data, and transfers the data to the first secondary storage device 300 (step S223).

At the step S320, the first secondary storage device 300, receiving the data copied through the above-mentioned synchronous copy, writes the relevant copy data to the secondary volume (SVOL) of the synchronous pair. At the same time, at the step S321, the processor, for using in the copy with reference to the above-mentioned second asynchronous pair, creates journal data. At the step S322, the relevant processor stores the data in the journal volume. In this situation, the processor does not transfer the relevant journal data to the second secondary storage device 400. At the step S323, the processor, when creating the above-mentioned journal data, counts up the SEQ# for the already created journals. The journal management table in the first secondary storage device 300 is, for example, configured as shown in FIG. 42.

On the other hand, the second secondary storage device 400, receiving the journal data asynchronously copied from the primary storage device 200 (step S420), restores the relevant journal data to the secondary volume (SVOL) of the first asynchronous pair (step S421). At this restore, to be exact, the data is temporarily stored in the journal volume and is written from the relevant journal volume to the secondary volume (SVOL) of the first asynchronous pair and restored. In this situation, the processor counts up the SEQ# for the already restored journals (step S422). The journal management table of the second secondary storage device 400 is as shown in FIG. 43.

Note that, for preventing the journal volume of the first secondary storage device 300 from being full, between the first and second secondary storage devices 300 and 400, communication is performed regularly and, by transmitting the SEQ# for the already restored journal data to the first secondary storage device 300, from the journal volume of the first secondary storage device 300, deletes (purges) the journal data already restored to the second secondary storage device 400.

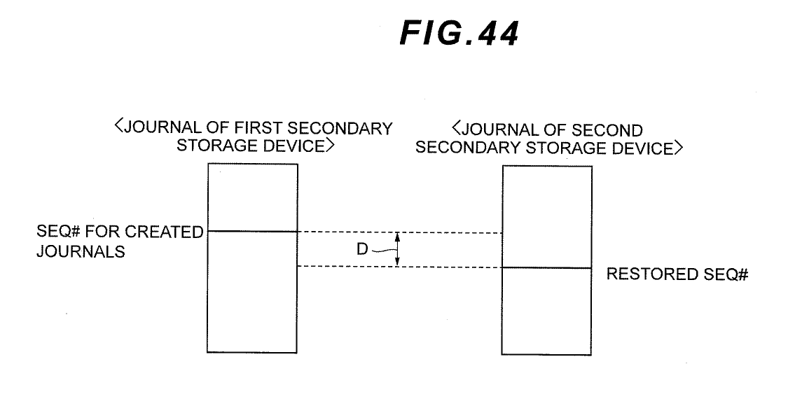

FIG. 44 is a diagram showing an example of the method for creating differential data. If the resync operation is performed for the second asynchronous pair, communication is performed between the first secondary storage device 300 and the second secondary storage device 400, the SEQ# for the already created journals and the SEQ# for the already restored journals are negotiated, and the differential data is transferred from the first secondary storage device 300 to the second secondary storage device 400. The relevant differential data is written to the secondary volume 400a (SVOL) of the second asynchronous pair in the second secondary storage device 400 and restored.

As more specifically described, the difference D between the SEQ# for the already created journals in the first secondary storage device 300 and the SEQ# for the already restored journals in the second secondary storage device 400 becomes the differential data between the first secondary storage device 300 and the second secondary storage device 400. For performing resync for a pair of the second asynchronous pair, this differential data is copied from the first secondary storage device 300 to the second secondary storage device 400.

(4) Advantageous Effects of the Present Embodiment and Others

As mentioned above, in the storage system 1 by the above-mentioned embodiment, the host computer 100 copies the differential data of the copy data stored in the first secondary volume 300a of the first secondary storage device 300 to the second secondary volume 400a of the second secondary storage device 400 with reference to the trigger that the respective status of the primary storage device 200 and the first secondary storage device 300 were changed to the Suspend status.

According to this type of configuration, even if the primary storage device 200 and the first secondary storage device 300 are changed to the Suspend status, the host computer 100 can continue the processing from the data without losing the data received from the host computer 100. For example, in case data copy is being performed asynchronously between the first and second secondary storage devices 300 and 400, the differential data is transferred to the second secondary storage device 400 with reference to the trigger that the failure occurred. Therefore, the host computer 100 can resume the processing from the data as it was right before the relevant failure occurred regardless of the timing when the failure occurred.

In the above-mentioned storage system 1, the host computer 100 comprises the status management units 100b and 100c for acquiring the respective status of the primary storage device 200, the first and second secondary storage devices 300 and 400, and the input/output control unit 100a that issues to the first secondary storage device 300 the command for copying the above differential data and transferring to the second secondary storage device 400 with reference to the trigger that the respective status of the primary storage device 200 and the first secondary storage devices 300 are acquired as the Suspend status by these status management units 100b and 100c.

As a result, when the respective status of the primary storage device 200 and the first secondary storage device 300 are changed to the Suspend status, in the host computer 100 the input/output control unit 100a reads the differential data of the second volume 300a in the second secondary storage device 300, and can continuously keep the operation at the point when changed to the relevant Suspend status.

The above-mentioned storage system 1 comprises the synchronous status management unit 100b and the asynchronous status management unit 100c as a part of the host applications, also as the above-mentioned status management units 100b and 100c. The synchronous status management unit 100b synchronously manages the respective status of the primary storage device 200 and the first secondary storage device 300. On the other hand, the asynchronous status management unit 100c manages not only the respective status of the primary storage device 200 and the second secondary storage device 400 asynchronously, but also the respective status of the first secondary storage device 300 and the second secondary storage device 400 asynchronously. That is, the first and second asynchronous pairs are respectively managed by the host application.

With this arrangement, even while data copy is asynchronously being performed between the first and second secondary storage devices 300 and 400, the differential data is transferred to the second secondary storage device 400 with reference to the trigger that the failure occurred. Therefore, the host computer 100 can resume the processing from the data as it was right before the relevant failure occurred regardless of the timing when the failure occurred. Because the host computer 100 can continues the processing from the data as it was right before the relevant failure occurred regardless of the timing when the failure occurred below, the date is never lost.

Also, in the above-mentioned storage system 1, the first and second secondary storage devices 300 and 400 respectively comprise the first and second secondary status management tables 300d and 400d for managing own status.

In the above-mentioned storage system 1, the first and second status management tables 300d and 400d respectively manage the asynchronous pairs, managed asynchronously by the asynchronous status management unit 100c, as the combination of the respective status of the first and second secondary storage devices 300 and 400. The first secondary storage device 300 transfers the differential data of the first volume 300a to the second storage device 400a as the destination identified by the asynchronous pair when triggered by receiving the command for copying the differential data from the host computer 100.

Also, in the above-mentioned storage system 1, the first secondary storage device 300 changes the status of the respective storage devices identified by the groups for managing the order of updating the data, and transfers the relevant differential data to the second secondary storage device 400, when triggered by receiving the command for copying the differential data from the host computer 100.

Also, in the above-mentioned storage system 1, as the asynchronous pairs comprise the first asynchronous pair as the combination of the respective status of the primary storage device 200 and the second secondary storage device 400, and the second asynchronous pair as the combination of the respective status of the first and second secondary storage devices 300 and 400. The first secondary storage device 300 changes the respective status of the volume identified by the volumes corresponding to the relevant group and the mirror ID for separately managing the first and second secondary volumes 300a and 400a corresponding to the second asynchronous pair, and transfers the differential data to the second secondary volume 400a, when triggered by receiving the command for copying the differential data.

In the above-mentioned storage system 1, the host computer 100 copies the differential data to the second secondary volume 400a in the second secondary storage device 400 with reference to the trigger that the respective status of the primary storage device 200 and the first secondary storage device 300 are changed to the Suspend status by at least one of the primary storage device 200 and the first secondary storage device 300 being changed to the Maintenance status, and by a failure occurred to the other.

According to the data duplication method in the storage system 1 in the above embodiment, the following acquisition step and the transfer step are performed. At the relevant acquisition step, the host computer 100 acquires that the respective status of the primary storage device 200 and the first secondary storage device 300 were both changed to the Suspend status. At the above transfer step, the host computer 100 transfers the differential data between the copy data stored in the first secondary volume 300a and the second secondary volume 400a from the first secondary storage device 300 to the second secondary storage device 400, with reference to the trigger that the status of the primary storage device 200 and the first secondary storage device 300 are both changed to the Suspend status at the above acquisition step.

In the above data duplication method, the first secondary storage device 300 copies the differential data in the first volume 300a and transfers the data to the second secondary storage device 400 as the destination identified by the asynchronous pair as the combination of the respective status of the first and second secondary storage devices 300 and 400 when triggered by receiving the command for copying the differential data from the host computer 100.

The above data duplication method, when triggered by receiving the command for copying the differential data from the host computer 100, the respective status of the storage devices identified in accordance with the groups for managing the order of updating the data in each volume or among volumes are changed, and the above differential data is transferred to the second secondary storage device 400.

In the above data duplication method, the above asynchronous pair comprises the first asynchronous pair as the combination of the respective status of the primary storage device 200 and the second secondary storage device 400 and the second asynchronous pair as the combination of the respective status of the first and second secondary storage devices 400. Further, the first secondary storage device 300 changes the respective status of the volumes identified by the volumes corresponding to the above group and the mirror ID for separately managing the first and second secondary volumes 300a and 400a corresponding to the second asynchronous pair, and transfers the differential data to the second secondary volume 400a, when triggered by receiving the command for copying the differential data from the host computer 100.

In the above data duplication method, in the above acquisition step, it is acquired that the respective status of the primary storage device 200 and the first secondary storage device 300 are changed to the Suspend status with reference to the trigger that at least one status of the primary storage device 200 and the first secondary storage device 300 changes to the Maintenance status and a failure occurred to the other.

Other Embodiments

The above-mentioned embodiment is merely explanatory for the present invention and the scope of the invention is not limited to the present embodiment. The present invention may be embodied in various other forms without departing from the scope of the invention. For example, though the above-mentioned embodiment describes the processing of the various types of programs sequentially, the order is not particularly limited to this. Therefore, as long as the result of the processing is consistent, the order of the processing may also be permitted to be switched or configured for the concurrent operation.

1. A storage system comprising:
a primary storage device comprising a primary volume storing data from a host device, on which data write is suspended with reference to a command from the host device;
a first secondary storage device comprising a first secondary volume storing copy data of the data stored in the primary volume; and
a second secondary storage device comprising a second secondary volume storing the copy data of the data stored in the primary volume; wherein
the host device transfers differential data between the respective copy data stored in the first and second secondary volumes from the first secondary storage device to the second secondary storage device with reference to a trigger that both status of the primary storage device and the first secondary storage device were changed to suspend status.

2. The storage system according to claim 1, wherein the host device comprises:
a status management unit for acquiring the respective status of the primary storage device, the first and second secondary storage devices; and
a input/output control unit that issues to the first secondary storage device a command for copying the differential data and transferring to the second secondary storage device with reference to the trigger that the respective status of the primary storage device and the first secondary storage devices are acquired as the suspend status by the status management unit.

3. The storage system according to claim 2, wherein the status management unit comprising:
a synchronous status management unit for synchronously managing the respective status of the primary storage device and the first secondary storage device; and
a asynchronous status management unit for asynchronously managing the respective status of the primary storage device and the second secondary storage device, while asynchronously managing the respective status of the first secondary storage device and the second secondary storage device.

4. The storage system according to claim 3, wherein
the first secondary storage device comprises a first status management table for managing the status of the first secondary device; and
the second secondary storage device comprises a second status management table for managing the status of the second secondary device.

5. The storage system according to claim 4, wherein
the first and second status management tables respectively manage the asynchronous pair as the combination of the respective status of the first and second secondary storage devices, which are asynchronously managed by the asynchronous status management unit, and
the first secondary storage device transfers the differential data to the second storage device as a destination identified by the asynchronous pair when triggered by receiving the command for copying the differential data from the host device.

6. The storage system according to claim 5, wherein
the first secondary storage device changes the status of the respective storage devices identified based on groups for managing the order of updating the data in each of the volumes or between the volumes, and transfers the differential data to the second secondary storage device, when triggered by receiving the trigger that the command for copying the differential data from the host device.

7. The storage system according to claim 6, wherein the asynchronous pairs comprises:
a first asynchronous pair as the combination of the respective status of the primary storage device and the second secondary storage device; and
a second asynchronous pair as the combination of the respective status of the first and second secondary storage devices, wherein
the first secondary storage device changes the respective status of volumes identified by a volume corresponding to the group and a pair discriminative sign for separately managing the first and second secondary volumes corresponding to the second asynchronous pair, and transfers the differential data to the second secondary volume, when triggered by receiving the command for copying the differential data.

8. The storage system according to claim 1, wherein
the host device copies the differential data to the second secondary volume with reference to the trigger that the respective status of the primary storage device and the first secondary storage device are changed to the suspend status by at least one of the primary storage device and the first secondary storage device being changed to the maintenance status, and by a failure occurred to the other.

9. A data duplication method in a storage system comprising:
a primary storage device comprising a primary volume storing data from a host device, on which data write is suspended based on a command from the host device;
a first secondary storage device comprising a first secondary volume storing copy data of the data stored in the primary volume, and;
a second secondary storage device comprising a second secondary volume storing the copy data of the data stored in the primary volume, wherein the data duplication method comprising:
an acquisition step at which the host device acquires respective status of the primary storage device and the first secondary storage device, and
a transfer step at which the host device transfers differential data between the respective copy data stored in the first and second secondary volumes from the first secondary storage device to the second secondary storage device with reference to a trigger that both status of the primary storage device and the first secondary storage device were changed to suspend status.

10. The data duplication method in the storage system according to claim 9, wherein
the first secondary storage device copies the differential data of the first volume and transfers the data to the second secondary storage device as a destination identified by an asynchronous pair as a combination of the respective status of the first and second secondary storage devices when triggered by receiving the command for copying the differential data from the host device.

11. The data duplication method in the storage system according to claim 10, wherein
the first secondary storage system changes the respective status of the storage devices identified based on groups for managing the order of updating the data in each of the volumes or between the volumes, and transfers the differential data to the second secondary storage device, with reference to the trigger that the command for copying the differential data is received from the host device.

12. The data duplication method in the storage system according to claim 11, wherein the asynchronous pair comprises;
a first asynchronous pair as a combination of the respective status of the primary storage device and the second secondary storage device and
a second asynchronous pair as a combination of the respective status of the first and second secondary storage devices, wherein
the first secondary storage device changes the respective status of the volumes identified by a volume corresponding to the group and a pair distinguishable sign for separately managing the first and second secondary volumes corresponding to the second asynchronous pair, and transfers the differential data to the second secondary volume, when triggered by receiving the command for copying the differential data by the host device.

13. The data duplication method in the storage system according to claim 9, wherein
in the acquisition step, it is acquired that the respective status of the primary storage device and the first secondary storage device are changed to the suspend status with reference to the trigger that at least one status of the primary storage device and the first secondary storage device changes to the maintenance status and a failure occurred to the other.
